(19) United States
(12) Patent Application Publication
(10) Pub. No.: US 2026/0187987 A1
(43) Pub. Date: Jul. 2, 2026

(54) Method And Apparatus For Generating Medical Image Analysis Model

(71) Applicant: W. AI CO., LTD., Seoul (KR)

(72) Inventors: Jae Hong Kim, Seoul (KR); Ho Heon KIM, Seoul (KR); Won Chan JEONG, Seoul (KR); Kyungran PI, Seoul (KR); Angela Soeun LEE, Seoul (KR); Min Soo KIM, Gyeonggi-do (KR); Hye Jin KIM, Seoul (KR)

(73) Assignee: W. AI CO., LTD., Seoul (KR)

(21) Appl. No.: 19/299,889

(22) Filed: Aug. 14, 2025

(30) Foreign Application Priority Data
Aug. 14, 2024 (KR) 10-2024-0109290
Dec. 2, 2024 (KR) 10-2024-0176539

(51) Int. Cl. G06V 10/776; G06T 7/00; G06T 7/40; G06V 10/26

(52) U.S. Cl. CPC G06V 10/776; G06T 7/0012; G06T 7/40; G06V 10/26; G06T 2207/10004; G06T 2207/20081; G06T 2207/30052

(57) ABSTRACT

According to some embodiments of the present disclosure, a medical image analysis method performed by a computing device is disclosed. The method may include: acquiring a first dataset including a medical image obtained by photographing the prosthesis, inserted into the body, by a first photographing device and a second dataset including a medical image obtained by photographing the prosthesis, inserted into the body, by a second photographing device, wherein the first dataset includes a medical image having a higher resolution than the second dataset; training an analysis model for determining cell type information of the prosthesis by using the first dataset; and validating the analysis model by using the first dataset and the second dataset.

### CROSS-REFERENCE TO RELATED APPLICATIONS

This application claims priority to and the benefit of Korean Patent Application No. 10-2024-0109290 filed in the Korean Intellectual Property Office on Aug. 14, 2024, and No. 10-2024-0176539 filed in the Korean Intellectual Property Office on Dec. 2, 2024, the entire contents of which are incorporated herein by reference.

### TECHNICAL FIELD

The present disclosure relates to a medical image analysis method, and more particularly, to a method and an apparatus for generating an analysis model for analyzing a medical image obtained by photographing a prosthesis inserted into a body.

### BACKGROUND ART

A prosthesis is a device that is inserted into a body for a medical or cosmetic purpose. There are various types of prostheses, such as a breast prosthesis, a joint replacement prosthesis, and a dental implant. These prosthesis can be inserted into the body with an aim of assisting a body function of a patient or improving an external appearance. However, the prosthesis inserted into the body can cause various side effects over time. For example, rupture, deformation, an inflammatory reaction in a tissue, formation of a coating, and the like of the prosthesis have been reported as representative side effects. These side effects may have a serious effect on a health of the patient if not detected early.

Regular examination after insertion of the prosthesis is essential. Ultrasonography is one of the diagnostic methods mainly used for this purpose. The ultrasonography has an advantage of being free from radiation exposure and being able to provide images in real time. Therefore, the ultrasonography is widely used as a non-invasive method of confirming a state of the prosthesis. However, a process of analyzing an ultrasound image is quite subjective, and it is difficult to accurately determine a state of the prosthesis or whether there is a side effect. In particular, when deformation or rupture of the prosthesis is minute, a high degree of skill is required to visually confirm the minute deformation or rupture.

Accordingly, there is a demand for a method and an apparatus that can more accurately monitor a condition of a prosthesis inserted into the body and detect side effects that may result therefrom early.

### SUMMARY OF THE INVENTION

The present disclosure is contrived in response to the above-described background art, and has been made in an effort to provide a method and an apparatus for generating an analysis model for analyzing a medical image obtained by photographing a prosthesis inserted into a body.

In order to implement the above-described object, disclosed is a method for generating an analysis model for determining cell type information of a prosthesis inserted into a body, performed by a computing device. The method may include: acquiring a first dataset including a medical image obtained by photographing the prosthesis, inserted into the body, by a first photographing device and a second dataset including a medical image obtained by photographing the prosthesis, inserted into the body, by a second photographing device, wherein the first dataset includes a medical image having a higher resolution than the second dataset; training an analysis model for determining cell type information of the prosthesis by using the first dataset; and validating the analysis model by using the first dataset and the second dataset.

Alternatively, the first photographing device may be a photographing device manufactured by a different manufacturer from the second photographing device.

Alternatively, the method may further include performing a preprocessing of cutting a side area of a medical image, included in the first dataset or the second dataset, at a predetermined ratio.

Alternatively, the training of the analysis model for determining the cell type information of the prosthesis by using the first dataset may include training the analysis model by using a loss function that imposes a high penalty to misclassification for a texture type compared to a smooth type among the cell type information of the prosthesis.

Alternatively, the validating of the analysis model by using the first dataset and the second dataset may include: performing cross validation for the analysis model by using the first dataset; and performing external validation for the analysis model by using the second dataset.

Alternatively, the validating of the analysis model by using the first dataset and the second dataset may further include performing the external validation for the analysis model by additionally using a fifth dataset including a publicly available image.

Alternatively, the method further include performing quantitative validation for the analysis model by using a medical image in which a pixel having a low classification contribution is masked according to a predetermined ratio to determine the cell type information of the prosthesis based on a pixel corresponding to a layer of the prosthesis.

Alternatively, the method may further include: acquiring a third dataset including a medical image obtained by photographing a state in which the prosthesis inserted into the body is ruptured and a fourth dataset including a medical image obtained by photographing a state in which no prosthesis is inserted into the body; and performing uncertainty estimation for the analysis model by using at least some of the first dataset, the second dataset, the third dataset, or the fourth dataset.

Alternatively, the performing of the uncertainty estimation for the analysis model by using at least some of the first dataset, the second dataset, the third dataset, or the fourth dataset may include performing uncertainty estimation for the analysis model based on a hypothesis that the third dataset has a higher prediction uncertainty than the first dataset or the second dataset and the fourth dataset has a higher prediction uncertainty than the third dataset.

Alternatively, the method may further include performing post-hoc explainable interpretation for the analysis model to generate region information representing a pixel, related to the cell type information of the prosthesis, using a classification contribution of the pixel to the cell type information of the prosthesis.

Alternatively, the region information may be represented in a heatmap format.

In order to achieve the above-described object, disclosed is a computer program stored in a computer readable storage medium. The computer program may include instructions that allow one or more processors to perform a method, and the method may include: acquiring a first dataset including a medical image obtained by photographing the prosthesis. inserted into the body, by a first photographing device and a second dataset including a medical image obtained by photographing the prosthesis, inserted into the body, by a second photographing device, wherein the first dataset includes a medical image having a higher resolution than the second dataset; training an analysis model for determining cell type information of the prosthesis by using the first dataset; and validating the analysis model by using the first dataset and the second dataset.

In order to achieve the above-described object, a computing device performing a method for generating an analysis model may include: a memory; and a processor, and the processor may be configured to: acquire a first dataset including a medical image obtained by photographing the prosthesis, inserted into the body, by a first photographing device and a second dataset including a medical image obtained by photographing the prosthesis, inserted into the body, by a second photographing device, wherein the first dataset includes a medical image having a higher resolution than the second dataset; train an analysis model for determining cell type information of the prosthesis by using the first dataset; and validate the analysis model by using the first dataset and the second dataset.

According to embodiments of the present disclosure, it is possible to provide a method and an apparatus for generating an analysis model for analyzing a medical image obtained by photographing a prosthesis inserted into a body.

### BRIEF DESCRIPTION OF THE DRAWINGS

FIG. 1 is a block diagram of a computing device for performing a medical image analysis method and a method for generating an analysis model for analyzing a medical image according to some embodiments of the present disclosure.

FIG. 2 is a schematic view illustrating a network function according to some embodiments of the present disclosure.

FIG. 3 is a schematic diagram of a medical image analysis system according to some embodiments of the present disclosure.

FIG. 4 is a diagram illustrating a block diagram of an exemplary side effect information generator according to some embodiments of the present disclosure.

FIG. 5 is a diagram illustrating a block diagram of an exemplary prosthesis information generator according to some embodiments of the present disclosure.

FIG. 6 is a schematic diagram of an analysis model generation system according to some embodiments of the present disclosure.

FIG. 7 is a diagram for describing a result for quantitative validation of an analysis model according to some embodiments of the present disclosure.

FIG. 8 is another diagram for describing a result for quantitative validation of an analysis model according to some embodiments of the present disclosure.

FIG. 9 is yet another diagram for describing a result for quantitative validation of an analysis model according to some embodiments of the present disclosure.

FIG. 10 is a diagram for describing a result for uncertainty estimation of the analysis model according to some embodiments of the present disclosure.

FIG. 11 is a diagram for describing a result for a post-hoc explainable interpretation of the analysis model according to some embodiments of the present disclosure.

FIG. 12 is a flowchart of a medical image analysis method according to some embodiments of the present disclosure.

FIG. 13 is a flowchart of a method for generating an analysis model according to some embodiments of the present disclosure.

FIG. 14 is a simple and normal schematic diagram of an exemplary computing environment in which the embodiments of the present disclosure may be implemented.

### DETAILED DESCRIPTION

Various embodiments and/or aspects will be now disclosed with reference to drawings. In the following description, for the purpose of a description, multiple detailed matters will be disclosed in order to help comprehensive appreciation of one or more aspects. However, those skilled in the art of the present disclosure will recognize that the aspect(s) can be executed without the detailed matters. In the following disclosure and the accompanying drawings, specific exemplary aspects of one or more aspects will be described in detail. However, the aspects are exemplary and some of various methods in principles of various aspects may be used and the descriptions are intended to include all of the aspects and equivalents thereof. Specifically, in “embodiment”, “example”, “aspect”, “illustration”, and the like used in the specification, it may not be construed that a predetermined aspect or design which is described is more excellent or advantageous than other aspects or designs.

Hereinafter, like reference numerals refer to like or similar elements regardless of reference numerals and a duplicated description thereof will be omitted. Further, in describing an embodiment disclosed in the present disclosure, a detailed description of related known technologies will be omitted if it is determined that the detailed description makes the gist of the embodiment of the present disclosure unclear. Further, the accompanying drawings are only for easily understanding the embodiment disclosed in this specification and the technical spirit disclosed by this specification is not limited by the accompanying drawings.

The terminology used in this specification is for the purpose of describing embodiments only and is not intended to limit the present disclosure. In this specification, singular forms include even plural forms unless the context clearly indicates otherwise. It is to be understood that the terms “comprise” and/or “comprising” used in the specification does not exclude the presence or addition of one or more other components other than stated components.

Although the terms “first”, “second”, and the like are used for describing various elements or components, these elements or components are not confined by these terms, of course. These terms are merely used for distinguishing one element or component from another element or component. Therefore, a first element or component to be mentioned below may be a second element or component in a technical spirit of the present disclosure.

Unless otherwise defined, all terms (including technical and scientific terms) used in the present specification may be used as the meaning which may be commonly understood by the person with ordinary skill in the art, to which the present disclosure pertains. Terms defined in commonly used dictionaries should not be interpreted in an idealized or excessive sense unless expressly and specifically defined.

In addition, the term “or” is intended to mean not exclusive “or” but implicit “or”. That is, when not separately specified or not clear in terms of a context, a sentence “X uses A or B” is intended to mean one of the natural inclusive replacements. That is, the sentence “X uses A or B” may be applied to any of the case where X uses A, the case where X uses B, or the case where X uses both A and B. Further, it should be understood that the term “and/or” used in this specification designates and includes all available combinations of one or more items among enumerated related items.

In addition, the term “at least one of A or B” should be interpreted to mean “a case including only A”, “a case including only B”, and “a case in which A and B are combined”

Those skilled in the art need to recognize that various illustrative logical blocks, configurations, modules, circuits, means, logic, and algorithm steps described in connection with the embodiments disclosed herein may be additionally implemented as electronic hardware, computer software, or combinations of both sides. To clearly illustrate the interchangeability of hardware and software, various illustrative components, blocks, constitutions, means, logic, modules, circuits, and steps have been described above generally in terms of their functionalities. Whether the functionalities are implemented as the hardware or software depends on a specific application and design restrictions given to an entire system. Skilled artisans may implement the described functionalities in various ways for each particular application. However, such implementation decisions should not be interpreted as causing a departure from the scope of the present disclosure.

The description of the presented embodiments is provided so that those skilled in the art of the present disclosure use or implement the present disclosure. Various modifications to the embodiments will be apparent to those skilled in the art. Generic principles defined herein may be applied to other embodiments without departing from the scope of the present disclosure. Therefore, the present disclosure is not limited to the embodiments presented herein. The present disclosure should be analyzed within the widest range which is coherent with the principles and new features presented herein.

In addition, the term “etc.” such as “A, B, etc.” should be interpreted to mean “a case including only A”, “a case including only B”, and “a case in which A and B are combined”.

Suffixes “module” and “unit” for components used in the following description are given or mixed in consideration of easy preparation of the specification only and do not have their own distinguished meanings or roles.

The objects and effects of the present disclosure, and technical constitutions of accomplishing these will become obvious with reference to embodiments to be described below in detail along with the accompanying drawings. In describing the present disclosure, a detailed description of known function or constitutions will be omitted if it is determined that it unnecessarily makes the gist of the present disclosure unclear. In addition, terms to be described below as terms which are defined in consideration of functions in the present disclosure may vary depending on the intention of a user or an operator or usual practice.

However, the present disclosure is not limited to embodiments disclosed below but may be implemented in various different forms. However, the embodiments are provided to make the present disclosure be complete and completely announce the scope of the present disclosure to those skilled in the art to which the present disclosure belongs and the present disclosure is just defined by the scope of the claims. Accordingly, the terms need to be defined based on contents throughout this specification.

FIG. 1 is a block diagram of a computing device for performing a medical image analysis method and a method for generating an analysis model for analyzing a medical image according to some embodiments of the present disclosure.

As illustrated in FIG. 1, the computing device 100 may include a processor 110, a memory 130, and a network unit 150. A configuration of the computing device 100 illustrated in FIG. 1 is only a simplified example. In some embodiments of the present disclosure, the computing device 100 may include other components for performing a computing configuration of the computing device 100 and only some of the disclosed components may constitute the computing device 100.

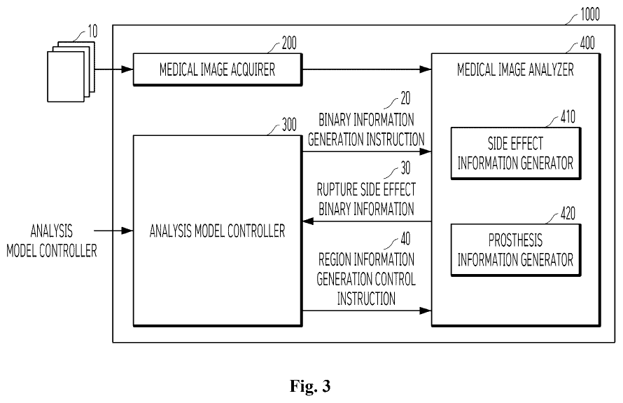

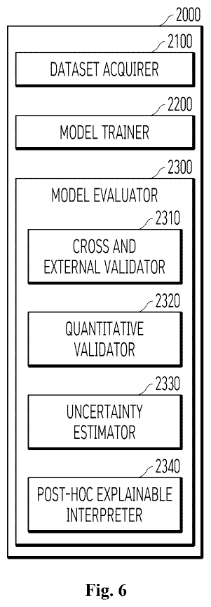

The processor 110 may be constituted by one or more cores and may include processors for data analysis and processing, and deep learning, which include a central processing unit (CPU), a general purpose graphics processing unit (GPGPU), a tensor processing unit (TPU), and the like of the computing device. The processor 110 may read a computer program stored in the memory 130 to perform data conversion, operation, generation, etc., for performing a medical image analysis method according to some embodiments of the present disclosure. For example, as described with reference to FIGS. 3 to 5, the processor 110 may perform steps for performing the medical image analysis method through a medical image analysis system. To this end, the processor 110 may implement a medical image analysis system 1000 and components thereof. Further, the processor 110 may read a computer program stored in the memory 130 to perform data conversion, operation, generation, etc., for performing a method for generating an analysis model according to some embodiments of the present disclosure. For example, as described with reference to FIGS. 6 to 11, the processor 110 may perform steps for performing a method for generating an analysis model through an analysis model generation system. To this end, the processor 110 may implement an analysis model generation system and components thereof. Further, according to some embodiments of the present disclosure, the processor 110 may perform an operation for training a neural network by using training data in order to perform the method for generating the analysis model. The processor 110 may perform calculations for training the neural network, which include processing of input data for learning in deep learning (DL), extracting a feature in the input data, calculating an error, updating a weight of the neural network using backpropagation, and the like. At least one of the CPU, the GPGPU, and the TPU of the processor 110 may process an operation for performing a medical image analysis method or a method for generating an analysis model. For example, both the CPU and the GPGPU may jointly process the operation for performing the medical image analysis method or the method for generating an analysis model. Further, in some embodiments of the present disclosure, processors of a plurality of computing devices may be used together to process data conversion, operation, and generation, learning of a network function and data classification using the network function for performing the medical image analysis method or the method for generating an analysis model. Further, the computer program executed in the computing device according to some embodiments of the present disclosure may be a CPU, GPGPU, or TPU executable program.

According to some embodiments of the present disclosure, the memory 130 may store any type of information generated or determined by the processor 110 or any type of information received by the network unit 150. For example, the memory 130 may store data generated in a process of performing the medical image analysis method or the method for generating an analysis model by the processor 110. Further, the memory 130 may store data externally received in the process of performing the medical image analysis method or the method for generating an analysis model by the processor 110. However, the present disclosure is not limited thereto, and the memory 130 may store various information for performing the medical image analysis method or the method for generating an analysis model according to some embodiments of the present disclosure.

According to some embodiments of the present disclosure, the memory 130 may include at least one type of storage medium of a flash memory type storage medium, a hard disk type storage medium, a multimedia card micro type storage medium, a card type memory (for example, an SD or XD memory, or the like), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disk. The computing device 100 may operate in connection with a web storage performing a storing function of the memory 130 on the Internet. The above description of the memory is just an example and the present disclosure is not limited thereto.

The network unit 150 according to some embodiments of the present disclosure may use an arbitrary type of known wired/wireless communication system.

The network unit 150 may transmit and receive information processed by the processor 110, a user interface, and the like through communication with other terminals. For example, the network unit 150 may provide the user interface generated by the processor 110 to a client (e.g., a user terminal). In addition, the network unit 150 may receive an external input of a user applied to a client and transfer the external input to the processor 110. In this case, the processor 110 may process operations such as outputting, correcting, changing, adding, and the like of information provided through the user interface based on the external input of the user received from the network unit 150.

Specifically, for example, the network unit 150 may transmit and receive various information for performing the medical image analysis method or the method for generating an analysis model according to some embodiments of the present disclosure. For example, the network unit 150 may receive one or more medical images stored in a database or a dataset including a medical image. Further, the memory 150 may transmit some data generated in a process of performing the medical image analysis method or the method for generating an analysis model described below to the outside. For example, the network unit 150 may transmit an analysis result of processing the medical image through the analysis model to the outside.

Meanwhile, according to some embodiments of the present disclosure, the computing device 100 may include a server as a computing system that transmits and receives information through communication with the client. In this case, the client may be any type of terminal which may access the server. For example, the computing device 100 which is the server may receive a query from a user terminal and generate a single information processing result corresponding to the query. In this case, the computing device 100 which is the server may provide, to the user terminal, a user interface including the processing result. In this case, the user terminal may output the user interface received from the computing device 100 as the server, and receive or process information through interaction with the user.

In an additional embodiment, the computing device 100 may also include any type of terminal that receives data resources generated by an arbitrary server and performs additional information processing.

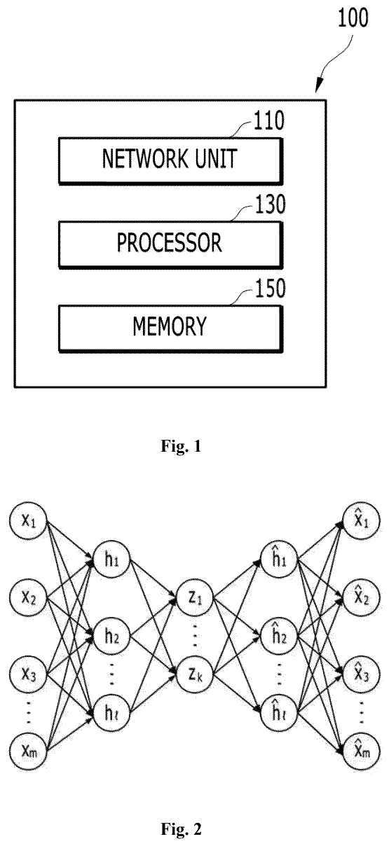

FIG. 2 illustrates an exemplary structure of an artificial intelligence based model according to some embodiments of the present disclosure.

Throughout the present disclosure, the artificial intelligence model, an artificial intelligence based model, a computation model, a neural network, a network function, and a neural network may be used as the same meaning.

The neural network may be constituted by an aggregate of calculation units which may be generally called nodes and are mutually connected to each other. The nodes may also be called neurons. The neural network is configured to include one or more nodes. The nodes (or neurons) constituting the neural networks may be connected to each other by one or more links.

In the neural network, one or more nodes connected through the link may relatively form the relationship between an input node and an output node. Concepts of the input node and the output node are relative and a predetermined node which has the relationship of the output node with respect to one node may have the relationship of the input node in the relationship with another node and vice versa. As described above, the relationship of the input node to the output node may be generated based on the link. One or more output nodes may be connected to one input node through the link and vice versa.

In the relationship of the input node and the output node connected through one link, a value of data of the output node may be determined based on data input in the input node. Here, a link connecting the input node and the output node to each other may have a weight. The weight may be variable and may vary by a user or an algorithm in order for the neural network to perform a desired function. For example, when one or more input nodes are mutually connected to one output node by the respective links, the output node may determine an output node value based on values input in the input nodes connected with the output node and the weights set in the links corresponding to the respective input nodes.

As described above, in the neural network, one or more nodes are connected to each other through one or more links to form a relationship of the input node and output node in the neural network. A characteristic of the neural network may be determined according to the number of nodes, the number of links, correlations between the nodes and the links, and values of the weights, granted to the respective links, in the neural network. For example, when the same number of nodes and links exist and there are two neural networks in which the weight values of the links are different from each other, it may be recognized that two neural networks are different from each other.

The neural network may be constituted by a set of one or more nodes. A subset of the nodes constituting the neural network may constitute a layer. Some of the nodes constituting the neural network may constitute one layer based on the distances from the initial input node. For example, a set of nodes of which distance from the initial input node is n may constitute n layers. The distance from the initial input node may be defined by the minimum number of links from the initial input node up to the corresponding node. However, definition of the layer is predetermined for description and the order of the layer in the neural network may be defined by a method different from the aforementioned method. For example, the layers of the nodes may be defined by the distance from a final output node.

In an embodiment of the present disclosure, a set of neurons or nodes may be defined as an expression such as layer.

The initial input node may mean one or more nodes in which data is directly input without passing through the links in the relationships with other nodes among the nodes in the neural network. Alternatively, in the neural network, in the relationship between the nodes based on the link, the initial input node may mean nodes which do not have other input nodes connected through the links. Similarly thereto, the final output node may mean one or more nodes which do not have the output node in the relationship with other nodes among the nodes in the neural network. Further, a hidden node may mean not the initial input node and the final output node but the nodes constituting the neural network.

In the neural network according to an embodiment of the present disclosure, the number of nodes of the input layer may be the same as the number of nodes of the output layer, and the neural network may be a neural network of a type in which the number of nodes decreases and then increases again from the input layer to the hidden layer. Further, in the neural network according to another embodiment of the present disclosure, the number of nodes of the input layer may be smaller than the number of nodes of the output layer, and the neural network may be a neural network of a type in which the number of nodes increases from the input layer to the hidden layer. Further, in the neural network according to yet another embodiment of the present disclosure, the number of nodes of the input layer may be larger than the number of nodes of the output layer, and the neural network may be a neural network of a type in which the number of nodes decreases from the input layer to the hidden layer. The neural network according to yet another embodiment of the present disclosure may be a neural network of a type in which the aforementioned neural networks are combined.

The artificial intelligence based model according to an embodiment of the present disclosure may include a deep neural network (DNN). The deep neural network may mean a neural network including a plurality of hidden layers other than the input layer and the output layer. When the deep neural network is used, the latent structures of data may be determined. That is, photos, text, video, voice, a protein sequence structure, a gene sequence structure, a peptide sequence structure, music latent structure (e.g., which objects are in the photo, what the content and feelings of the text are, what the content and feelings of the voice are, etc.), and/or a binding affinity between the peptide and MHC may be determined. The deep neural network may include a convolutional neural network (CNN), a recurrent neural network (RNN), an auto encoder, a restricted Boltzmann machine (RBM), a deep belief network (DBN), a Q network, a U network, a Siam network, a Generative Adversarial Network (GAN), a transformer, and the like. The aforementioned description of the deep neural network is just an example and the present disclosure is not limited thereto.

The artificial intelligence based model of the present disclosure may be expressed by a network structure with the any structure, which includes the input layer, the hidden layer, and the output layer.

The neural network which may be used in the artificial intelligence based model of the present disclosure may be trained in at least one scheme of supervised learning, unsupervised learning, semi supervised learning, transfer learning, active learning, or reinforcement learning. The training of the neural network may be a process in which the neural network applies knowledge for performing a specific operation to the neural network.

The neural network may be trained in a direction to minimize errors of an output. The training of the neural network is a process of repeatedly inputting learning data into the neural network and calculating the output of the neural network for the learning data and the error of a target and back-propagating the errors of the neural network from the output layer of the neural network toward the input layer in a direction to reduce the errors to update the weight of each node of the neural network. In the case of the supervised learning, the learning data in which each training data is labeled with a correct answer (i.e., the labeled learning data) may be used, and in the case of the unsupervised learning each training data may not be labeled with a correct answer. That is, for example, the learning data in the case of the supervised learning associated with the data classification may be data in which each training data is labeled with a category. The labeled learning data is input to the neural network, and the error may be calculated by comparing the output (category) of the neural network with the label of the learning data. As another example, in the case of the unsupervised learning associated with the data classification, the learning data as the input may be compared with the output of the neural network to calculate the error. The calculated error may be back-propagated in a reverse direction (i.e., a direction from the output layer toward the input layer) in the neural network, and connection weights of respective nodes of each layer of the neural network may be updated according to the back propagation. A variation amount of the updated connection weight of each node may be determined according to a learning rate. Calculation of the neural network for the input data and the back-propagation of the error may constitute a learning cycle (epoch). The learning rate may be applied differently according to the number of repetition times of the learning cycle of the neural network. For example, in an initial stage of the learning of the neural network, the neural network may ensure a certain level of performance quickly by using a high learning rate, thereby increasing efficiency, and may use a low learning rate in a latter stage of the learning, thereby increasing accuracy.

In the training of the neural network, the learning data may be generally a subset of actual data (i.e., data to be processed using the trained neural network), and as a result, there may exist a learning cycle in which errors for the learning data decrease, but the errors for the actual data increase. Overfitting is a phenomenon in which the errors for the actual data increase due to excessive learning of the learning data. For example, a phenomenon in which the neural network that learns a cat while seeing a yellow cat does not recognize a cat other than a yellow cat as a cat may be an example of overfitting. The overfitting may act as a cause which increases the error of the machine learning algorithm. Various optimization methods may be used in order to prevent the overfitting. In order to prevent the overfitting, a method such as increasing the learning data, regularization, dropout of omitting a part of the node of the network in the process of learning, utilization of a batch normalization layer, etc., may be applied.

Disclosed is a computer readable medium storing the data structure according to an embodiment of the present disclosure. The above-described data structure may be stored in the storage unit in the present disclosure, executed by the processor, and transmitted and received by the communication unit.

The data structure may refer to the organization, management, and storage of data that enables efficient access to and modification of data. The data structure may refer to the organization of data for solving a specific problem (e.g., data analysis, data search, data storage, data modification). The data structures may be defined as physical or logical relationships between data elements, designed to support specific data processing functions. The logical relationship between data elements may include a connection relationship between data elements that the user defines. The physical relationship between data elements may include an actual relationship between data elements physically stored on a computer-readable storage medium (e.g., persistent storage device). The data structure may specifically include a set of data, a relationship between the data, a function which may be applied to the data, or instructions. Through an effectively designed data structure, a computing device can perform operations while using the resources of the computing device to a minimum. Specifically, the computing device can increase the efficiency of operation, read, insert, delete, compare, exchange, and search through the effectively designed data structure.

The data structure may be divided into a linear data structure and a non-linear data structure according to the type of data structure. The linear data structure may be a structure in which only one data is connected after one data. The linear data structure may include a list, a stack, a queue, and a deque. The list may mean a series of data sets in which an order exists internally. The list may include a linked list. The linked list may be a data structure in which data is connected in a scheme in which each data is linked in a row with a pointer. In the linked list, the pointer may include link information with next or previous data. The linked list may be represented as a single linked list, a double linked list, or a circular linked list depending on the type. The stack may be a data listing structure with limited access to data. The stack may be a linear data structure that may process (e.g., insert or delete) data at only one end of the data structure. The data stored in the stack may be a data structure (LIFO-Last in First Out) in which the data is input last and output first. The queue is a data listing structure that may access data limitedly and unlike a stack, the queue may be a data structure (FIFO-First in First Out) in which late stored data is output late. The deque may be a data structure capable of processing data at both ends of the data structure.

The non-linear data structure may be a structure in which a plurality of data are connected after one data. The non-linear data structure may include a graph data structure. The graph data structure may be defined as a vertex and an edge, and the edge may include a line connecting two different vertices. The graph data structure may include a tree data structure. The tree data structure may be a data structure in which there is one path connecting two different vertices among a plurality of vertices included in the tree. That is, the tree data structure may be a data structure that does not form a loop in the graph data structure.

Throughout the present disclosure, the artificial intelligence based model, the computation model, the neural network, the network function, and the neural network may be used as meanings which are interchangeable with each other. Hereinafter, the artificial intelligence based model, the computation model, the neural network, the network function, and the neural network will be integrated and described as the neural network. The data structure may include the neural network. In addition, the data structures, including the neural network, may be stored in a computer readable medium. The data structure including the neural network may also include data preprocessed for processing by the neural network, data input to the neural network, weights of the neural network, hyper parameters of the neural network, data obtained from the neural network, an active function associated with each node or layer of the neural network, and a loss function for training the neural network. The data structure including the neural network may include predetermined components of the components disclosed above. In other words, the data structure including the neural network may include all of data preprocessed for processing by the neural network, data input to the neural network, weights of the neural network, hyper parameters of the neural network, data obtained from the neural network, an active function associated with each node or layer of the neural network, and a loss function for training the neural network or a predetermined combination thereof. In addition to the above-described components, the data structure including the neural network may include predetermined other information that determines the characteristics of the neural network. In addition, the data structure may include all types of data used or generated in the calculation process of the neural network, and is not limited to the above. The computer readable medium may include a computer readable recording medium and/or a computer readable transmission medium. The neural network may be constituted by an aggregate of calculation units which may be generally called nodes and are mutually connected to each other. The nodes may also be called neurons. The neural network is configured to include one or more nodes.

The data structure may include data input into the neural network. The data structure including the data input into the neural network may be stored in the computer readable medium. The data input to the neural network may include learning data input in a neural network learning process and/or input data input to a neural network in which learning is completed. The data input to the neural network may include preprocessed data and/or data to be preprocessed. The preprocessing may include a data processing process for inputting data into the neural network. Therefore, the data structure may include data to be preprocessed and data generated by preprocessing. The data structure is just an example and the present disclosure is not limited thereto.

The data structure may include weights of the neural network (weights and parameters may be used as meanings which are interchangeable with each other in the present disclosure). In addition, the data structures, including the weight of the neural network, may be stored in the computer readable medium. The neural network may include a plurality of weights. The weight may be variable and may vary by a user or an algorithm in order for the neural network to perform a desired function. For example, when one or more input nodes are mutually connected to one output node by the respective links, the output node may determine a data value output from an output node based on values input in the input nodes connected with the output node and the weights set in the links corresponding to the respective input nodes. The data structure is just an example and the present disclosure is not limited thereto.

As a non-limiting example, the weight may include a weight which varies in the neural network learning process and/or a weight in which neural network learning is completed. The weight which varies in the neural network learning process may include a weight at a time when a learning cycle starts and/or a weight that varies during the learning cycle. The weight in which the neural network learning is completed may include a weight in which the learning cycle is completed. Accordingly, the data structure including the weights of the neural network may include a data structure including the weights which vary in the neural network learning process and/or the weights in which neural network learning is completed. Accordingly, the above-described weight and/or a combination of each weight are included in a data structure including a weight of a neural network. The data structure is just an example and the present disclosure is not limited thereto.

The data structure including the weights of the neural network may be stored in the computer-readable storage medium (e.g., memory, hard disk) after a serialization process. Serialization may be a process of storing data structures on the same or different computing devices and later reconfiguring the data structure and converting the data structure to a form that may be used. The computing device may serialize the data structure to send and receive data over the network. The data structure including the weights of the serialized neural network may be reconfigured in the same computing device or another computing device through deserialization. The data structure including the weights of the neural network is not limited to the serialization. Furthermore, the data structure including the weights of the neural network may include a data structure (for example, B-Tree, R-Tree, Trie, m-way search tree, AVL tree, and Red-Black Tree in a nonlinear data structure) to increase the efficiency in the operation while minimally using resources of the computing device. The above-described matter is just an example and the present disclosure is not limited thereto.

The data structure may include hyper-parameters of the neural network. In addition, the data structures, including the hyper-parameters of the neural network, may be stored in the computer readable medium. The hyper-parameter may be a variable which may be varied by the user. The hyper-parameter may include, for example, a learning rate, a cost function, the number of learning cycle iterations, weight initialization (for example, setting a range of weight values to be subjected to weight initialization), and Hidden Unit number (e.g., the number of hidden layers and the number of nodes in the hidden layer). The data structure is just an example and the present disclosure is not limited thereto.

The artificial intelligence based model according to an embodiment of the present disclosure may include a large language model (LLM). The large language model in the present disclosure may mean an artificial intelligence based model trained by using a vast amount of learning data to perform natural language processing. The large language model may include the transformer, an encoder-series model of the transformer, and/or a decoder-series model of the transformer. The encoder-series model of the transformer may correspond to an artificial intelligence model using an encoder structure of the transformer. The decoder-series model of the transformer may correspond to an artificial intelligence model using a decoder structure of the transformer.

In an embodiment, the transformer may be constituted by an encoder that encodes input data and a decoder that decodes the encoded data. The transformer may have a structure which inputs a series of input data, and outputs a series of output data through encoding and decoding steps. In an embodiment, the series of input data may be processed in a form which is enabled to be computed by the transformer. A process of processing the series of input data in the form which is enabled to be computed by the transformer may include a tokenizing process and an embedding process. The tokenizing process may mean a process of dividing the series of input data into tokens of a predetermined unit. For example, the predetermined unit may include a word unit. The embedding process may mean a process of transforming at least one token tokenized from the series of input data into an embedding vector.

In an embodiment, the transformer may acquire an embedding vector to be input into the encoder by combining a token embedding vector which embeds at least one token corresponding to the series of input data, a segment embedding vector which segments a sentence including a token for each token, and a position embedding vector to which a position of the token is reflected. The encoder-series model and the decoder-series model of the transformer may also acquire the embedding vector by performing the same scheme.

In an embodiment, in order for the transformer to encode and decode a series of input data, the encoder and the decoder within the transformer may utilize an attention algorithm. The attention algorithm may mean an algorithm that calculates a similarity by applying a SoftMax function to an attention score acquired by a matrix product of a query and a key with respect to a given query, and calculates an attention value for the query by a matrix product of the calculated similarity and a value.

In an embodiment, a self-attention algorithm may mean an attention algorithm that uses the query, the key, and the value generated by multiplying the same embedding vector by each of a query weight, a key weight, and a value weight. A cross attention algorithm may mean an attention algorithm that uses a query generated by multiplying a first embedding vector by the query weight, and a key and a value generated by multiplying a second embedding vector by the key weight and the value weight, respectively. The query weight, the key weight, and the value weight may be trainable parameters which are updated through a training process of a large language model.

In an embodiment, the encoder of the transformer may include an embedding layer, a self-attention layer in which the self-attention algorithm is applied to the embedding vector, a normalization layer, and a feed forward neural network (FNN). Further, the encoder may have a form in which N unit structures including the self-attention layer, the normalization layer, and the feed forward neural network (FNN) are connected. The decoder of the transformer may include the embedding layer, a masked self-attention layer, the normalization layer, a cross attention layer to which the cross attention algorithm is applied, and the feed forward neural network (FNN). Further, the decoder may have a form in which N unit structures including the masked self-attention layer, the normalization layer, the cross attention layer, and the feed forward neural network are connected. The masked self-attention layer may correspond to a layer that obtains attention value each of the sequences sequentially including words in a plurality of words included in the series of input data.

The transformer may also include additional components such as a linear layer, a SoftMax layer, etc., in addition to the encoder and the decoder. Each of the encoder-series model of the transformer and the decoder-series model of the transformer may also include the additional components in addition to the encoder and the decoder. A method for constituting the transformer by using the attention algorithm may include a method disclosed in Vaswani et al., Attention Is All You Need, 2017 NIPS, which is incorporated herein by reference.

In an embodiment, the attention layer such as the self-attention layer, the masked self-attention layer, the cross attention layer, etc., may correspond to a multi-head attention layer including a plurality of attention layers in parallel. The multi-head attention layer matrix-concatenates attention values output from the plurality of attention layers, respectively, and matrix-multiplies the concatenated matrix by an output weight to output an output attention value. An output attention value output from the multi-head attention layer may have the same size as an attention value output from one attention layer.

In an embodiment, the transformer may be trained through a masked language model (MLM) process, a next sentence prediction (NSP) process, etc. The MLM process may mean a training process that predicts a masked word through a series of training data in which some words are masked. The NSP process may mean a training process that discriminates whether two sentences are concatenated in a series of training data including any two sentences.

In an embodiment, the large language model may process various data formats including image data, audio data, video data, etc., in addition to a natural language text. In order to transform data with various data formats into a series of data that are computable, the large language model may embed the data. The large language model may process additional data expressing a relative positional relationship or phase relationship between a series of input data. Alternatively, the series of input data may be embedded by additionally reflecting vectors expressing relative positional relationships or phase relationships between the input data to the series of input data. In one example, the relative positional relationship between a series of input data may include a word order within the natural language sentence, a relative positional relationship of respective segmented images, a temporal order of segmented audio waveforms, etc., but is not limited thereto. A process of adding information expressing a relative positional relationship or phase relationship between a series of input data may be referred to as positional encoding.

One example (Vision Transformer, ViT) of the large language model which processes image data is disclosed in Dosovitskiy, et al., An Image is Worth 16×16 Words: Transformers for Image Recognition at Scale, which is incorporated herein by reference.

The artificial intelligence model according to an embodiment of the present disclosure may include a multi-modal large language model. The multi-modal large language model may mean a large language model that may understand and process a relationship between different data formats including natural language text data, image data, audio data, video data, etc. The multi-modal language model may include a plurality of encoders which encode input data corresponding to each data format. The multi-modal language model may be trained to calculate a similarity between embedding vectors encoded from the encoder, which have respective data formats through training data including data with different data formats, calculate a similarity for the same pair to be higher, and calculate a similarity for different pairs to be lower.

One example (Contrastive Language-Image Pre-training, CLIP) of the multi-modal large language model which understands and processes the relationship between the image data and the natural language text data is disclosed in Alec Radford, et al., Learning Transferable Visual Models from Natural Language Supervision, which is incorporated herein by reference.

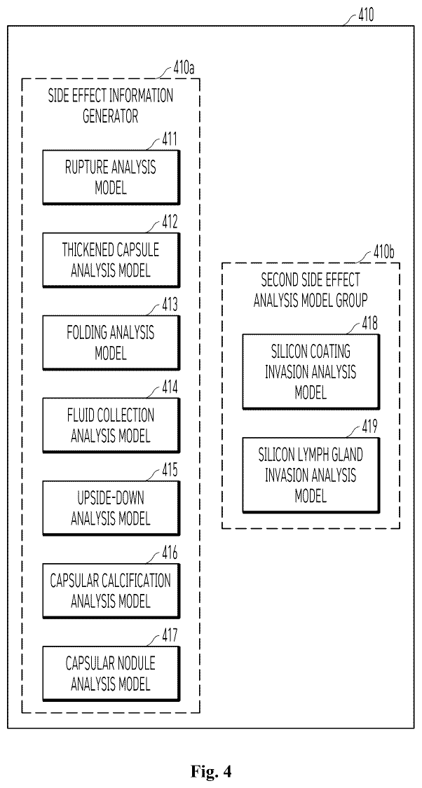

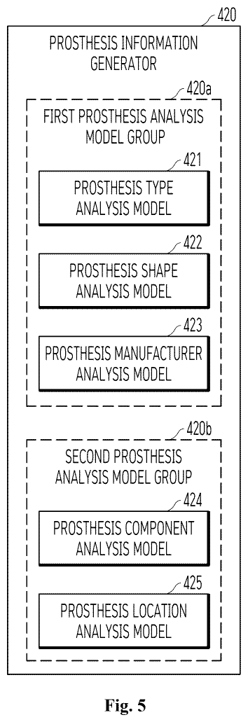

FIG. 3 is a schematic diagram of a medical image analysis system 1000 according to some embodiments of the present disclosure. FIG. 4 is a diagram illustrating a block diagram of an exemplary side effect information generator 410 according to some embodiments of the present disclosure. FIG. 5 is a diagram illustrating a block diagram of an exemplary prosthesis information generator 420 according to some embodiments of the present disclosure.

Hereinafter, an embodiment regarding the medical image analysis system 1000 that performs the medical image analysis method and components thereof according to some embodiments of the present disclosure will be described with reference to FIGS. 3 to 5.

The medical image analysis system 1000 according to some embodiments of the present disclosure may provide an analysis result of a medical image obtained by photographing a prosthesis inserted into the body. Specifically, the medical image analysis system 1,000 according to some embodiments of the present disclosure may generate side effect information and prosthesis information by processing the medical image obtained by photographing the prosthesis injected into the body. For example, the medical image analysis system 1000 according to some embodiments of the present disclosure may generate binary information representing information regarding the prostheses inserted into the body and information regarding side effects caused by the prosthetics inserted into the body as positive or negative. In addition, the medical image analysis system 1000 according to some embodiments of the present disclosure may provide a user with region information representing a region, in which a side effect such as a rupture occurs, in a visualization format such as a heat map that may be easily grasped by the user. However, the present disclosure is not limited thereto, and the medical image analysis system 1000 may provide the analysis result of the medical image obtained by photographing the prosthesis inserted into the body in various schemes.

In some examples, as illustrated in FIG. 3, the medical image analysis system 1000 may include a medical image acquirer 200, an analysis model controller 300, and a medical image analyzer 400. However, the present disclosure is not limited thereto, and the medical image analysis system 1000 may further include other components for providing an analysis result for a medical image, and only some of the disclosed components may constitute the medical image analysis system 1000.

According to some embodiments of the present disclosure, the medical image acquirer 200 may acquire the medical image obtained by photographing the prosthesis inserted into the body.

In some examples, the medical image acquirer 200 may acquire a medical image 10 to be analyzed by an analysis model. For example, the medical image acquirer 200 may receive a medical image registered through a user interface. In some examples, the medical image may include various types of images used for medical diagnosis, treatment, and research. For example, the medical image includes an X-ray (Radiography) image, a computed tomography (CT) image, a magnetic resonance imaging (MRI) image, or an ultrasound image. However, the present disclosure is not limited thereto, and the medical image may include various types of images capable of photographing the prosthesis inserted into the body. Further, an embodiment of a medical image obtained by photographing a pros thesis inserted into a breast will be described below, but the present disclosure is not limited thereto.

In some examples, the analysis model controller 300 may control the medical image analyzer 400 that processes the medical image. For example, when the medical image is acquired by the medical image acquirer 200, the analysis model controller 300 may control the medical image analyzer 400 (or the analysis model included in the medical image analyzer 400) to generate prosthesis information and side effect information as an analysis result by processing the medical image. In some examples, as described below, the analysis model controller 300 may transmit a binary information generation instruction 20 and a region information generation control instruction 40 to the medical image analyzer 400 in order to control the medical image analyzer 400. For example, the analysis model controller 300 may transmit a binary information generation instruction for activating a binary information generation operation of the analysis model included in the medical image analyzer 400 to the medical images analyzer 400. For example, the analysis model controller 300 may transmit a region information generation control instruction for activating or deactivating binary information generation instruction for activating a region information generation operation of the analysis model included in the medical image analyzer 400 to the medical images analyzer 400.

In some examples, the side effect information may include information regarding a side effect caused by the prosthesis inserted into the body. For example, the side effect information may include thickening capsule side effect information, folding side effect information, seroma side effect information, upside-down rotation side effect information, coating calcification side effect information, and coating nodule side effect information. However, the present disclosure is not limited thereto and the side effect information may include various information.

In some examples, the prosthesis information may include information regarding the side effect caused by the prosthesis inserted into the body. For example, the prosthesis information may include prosthesis type information, a prosthesis shape, prosthesis manufacturer information, prosthesis component information, prosthesis location information, etc. However, the present disclosure is not limited thereto and the prosthesis information may include various information.

According to some embodiments of the present disclosure, the prosthesis information and the side effect information may include binary information and region information corresponding to the binary information. In some examples, the binary information may indicate the information regarding the prosthesis inserted into the body and the information regarding the side effect caused by the prostheses inserted into the body as positive or negative. For example, binary information related to rupture side effect information may indicate whether rupture of the prosthesis occurs on the analyzed medical image as positive or negative. As another example, binary information related to the prosthesis manufacturer information may represent whether the prosthesis manufacturer information may be identified on the medical image, as positive or negative.

In some examples, the region information may include information indicating a region related to the prosthesis information and the side effect information. For example, region information related to the rupture side effect information may represent information representing a region where a rupture occurs. In some examples, the region information may be represented in a heatmap format. For example, the region information related to the rupture side effect information may represent a location where the rupture of the prosthesis occurs in the heatmap format in the medical image.

In some examples, the medical image analyzer 400 may generate prosthesis information and prosthesis information by processing the medical image. For example, as illustrated in FIG. 3, the medical image analyzer 400 may include a side effect information generator 410 and a prosthesis information generator 420. In some examples, the side effect information generator 410 may include a plurality of analysis models for generating various side effect information. For example, the side effect information generator 410 may include a rupture analysis model 411, a thickening capsule analysis model 412, folding analysis information 413, a seroma analysis model 414, a reverse rotation analysis model 415, a capsular calcification analysis model 416, and a capsular nodule analysis model 417, as illustrated in FIG. 4. However, the present disclosure is not limited thereto and the side effect information generator 410 may include various analysis models.

In some examples, as described below, the side effect information generator 410 may include a first side effect analysis group 410a constituted by an analysis model in which a region information generation operation is activated or deactivated according to rupture side effect binary information. Further, the side effect information generator 410 may include a second side effect analysis group 410b constituted by an analysis model in which the region information generation operation is activated or deactivated according to the rupture side effect binary information.

In some examples, prosthesis information generator 420 may include a plurality of analysis models for generating various prosthesis information. For example, as illustrated in FIG. 5, the prosthesis information generator 420 includes a prosthesis type analysis model 421, a prosthesis shape analysis model 422, a prosthesis manufacturer analysis model 423, a prostheses component analysis model 424, and a prosthesis location analysis model 425. However, the present disclosure is not limited thereto and the prosthesis information generator 420 may include various analysis models.

In some examples, as described below, the prosthesis information generator 420 may include a first prosthesis analysis group 420a constituted by an analysis model in which the region information generation operation is activated or deactivated according to the rupture side effect binary information. Further, as described below, the prosthesis information generator 420 may include a second prosthesis analysis group 420b constituted by an analysis model in which the region information generation operation is continuously activated regardless of the rupture side effect binary information.

Hereinafter, an embodiment in which the analysis model controller 300 controls region information generation operations of the first side effect analysis group 410a and the first prosthesis analysis group 420a will be described.

According to some embodiments of the present disclosure, the medical image analysis system 1000 may generate binary information by activating binary information generation operations of the first side effect analysis model group 410a and the first prosthesis analysis model group 420a by the analysis model controller 300.

Specifically, when the medical image acquirer 200 acquires the medical image 10, the analysis model controller 300 may receive an analysis instruction for the acquired medical image 10 from the user interface. The analysis model controller 300 may transmit a binary information generation instruction to the medical image analyzer 400 to activate the binary information generation operations of the first side effect analysis model group 410a and the first prosthesis analysis model group 420a in response to an analysis instruction. In this case, the medical image analyzer 400 may generate the binary information by activating the binary information generation operations of the first side effect analysis model group 410a and the first prosthesis analysis model group 420a. For example, the medical image analyzer 400 may generate the rupture side effect binary information representing whether the rupture of the prosthesis occurs on the medical image 10 as positive or negative by activating the binary information generation operations of the rupture analysis model 411 in the first side effect analysis model group 410a. As another example, the medical image analyzer 400 may generate prosthesis shape binary information representing whether information on a shape of the prosthesis is identified on the medical image as positive or negative by activating a binary information generation operation of the prosthesis shape analysis model 422 in the first side effect analysis model group 420a. In other words, the medical image analyzer 400 may generate a plurality of binary information by activating binary information generation operations of all analysis models belonging to the first side effect analysis model group 410a and the first prosthesis analysis model group 420a.

According to some embodiments of the present disclosure, the medical image analysis system 1000 may activate or deactivate the region information generation operations of the first side effect analysis model group 410a and the first prosthesis analysis model group 420a that generate region information corresponding to binary information based on rupture side effect binary information among the binary information.

The medical image analysis system 1000 may analyze the medical image efficiently by activating or deactivating the region information generation operation of the analysis model by using binary information regarding a clinically significant side effect such as a rupture side effect among various side effects that may be identified by analyzing the medical image. Specifically, the medical image analyzer 1000 may determine whether to activate the region information generation operations of the first side effect analysis model group 410a and the first prosthesis analysis model group 420a by using specific binary information among the binary information. The region information may require a computation for each pixel included in the medical image as compared to the binary information. Thus, the medical image analysis system 1000 may efficiently use resources by limitedly activating the region information generation operation. For example, when analyzing a medical image obtained by photographing a prosthesis inserted into a body, such as a breast, the rupture side effect, among other side effects, may be more clinically important than another side effect. In other words, for a medical image in which the rupture side effect is found, utilization of region information related to another side effect may be low. Thus, even when binary information for another side effect is positive for the medical image in which a rupture side effect is found, the medical image analysis system 1000 may save resources by deactivating region information generation operations for another side effect other than the rupture.

In some examples, the medical image analysis system 1000 may generate the region information corresponding to the binary information by the region information generation operation of the first side event analysis model group 410b and the first prosthesis analysis models group 420a by activating the region information generation operations of the first side effect analysis model group 410a and the first prosthesis analysis model group 420a in response to the rupture side effect binary information being negative. Specifically, the analysis model controller 300 may receive the rupture side effect binary information from the medical image analyzer 400. When the rupture side effect binary information is negative, the analysis model controller 300 may transmit, to the medical image analyzer 400, the region information generation control instruction 40 for activating the region information generation operations of the first side effect analysis model group 410a and the first prosthesis analysis model group 420a so as to generate the region information of another side effect on the medical image. In this case, each of the first side effect analysis model group 410a and the first prosthesis analysis model group 420a may generate the region information corresponding to the binary information. In other words, when the rupture side effect binary information is negative, each of the analysis model controller 300 may control the first side effect analysis model group 410a and the first prosthesis analysis model group 420a to generate both the binary information and the region information corresponding to the binary information.

In some examples, the medical image analysis system 1000 may deactivate the region information generation operations of the first side effect analysis model group and the first prosthesis analysis model group in response to the rupture side effect binary information being positive. Specifically, the analysis model controller 300 may receive the rupture side effect binary information from the medical image analyzer 400. When the rupture side effect binary information is positive, the analysis model controller 300 may transmit, to the medical image analyzer 400, the region information generation control instruction 40 for deactivating the region information generation operations of the first side effect analysis model group 410a and the first prosthesis analysis model group 420a so as not to generate the region information of another side effect other than the rupture on the medical image. In this case, each of the first side effect analysis model group 410a and the first prosthesis analysis model group 420a may generate only the binary information, but not generate the region information. In other words, when the rupture side effect binary information is positive, each of the analysis model controller 300 may control the first side effect analysis model group 410a and the first prosthesis analysis model group 420a to generate only the binary information.

In some examples, analysis models that belong to the first side effect analysis model group 410a and the first prosthesis analysis model group 420a may perform a binary information generation operation and a region information generation operation in various schemes. For example, the analysis model may be constituted by a binary information generation sub model that performs the binary information generation operation and a region information generation sub model that performs the region information generation operation. In this case, the analysis model controller 300 may deactivate region information generation sub models of the first side effect analysis model group 410a and the first prosthesis analysis model group 420a in response to deactivating the region information generation operations of the first side effect analysis model group 410b and the first prosthesis analysis model group 420a. In other words, in a case where the analysis model is constituted by two or more sub models that individually generate binary information and region information, respectively, the analysis model controller 300 may deactivate a region information generation sub model in response to deactivating the region information generation operation.

In some examples, the analysis model may be constituted by a single model that performs both the binary information generation operation and the region information generation operation. For example, the analysis model may perform a region information generation operation that calculates a classification contribution to binary information of a pixel included in the medical image. In this case, the analysis model controller 300 may deactivate ran operation of calculating the classification contribution to the binary information of the pixel included in the medical image of the first side effect analysis model group 410a and the first prosthesis analysis model group 420a in response to deactivating the region information generation operations of the first side effect analysis model group 410a and the first prosthesis analysis model group 420a. In other words, in a case where the analysis model is a single model that performs both the binary information generation operation and the region information generation operation, the analysis model controller 300 may perform only the binary information generation operation in response to deactivating the region information generation operation.

According to some embodiments of the present disclosure, the medical image analysis system 1000 may generate binary information and region information corresponding to the binary information by processing the acquired medical image 10 by a second side effect analysis model group 410b and a second prosthesis analysis model group 420b.

The medical image analysis system 1000 may efficiently analyze the medical image by using two types of analysis models that are classified according to whether the region information generation operation is controlled by using binary information regarding a specific side effect such as the rupture side effect. Specifically, for example, as a type of analysis model that is controlled to restrictively perform a region information generation operation according to binary information for a specific side effect such as the rupture side effect, the medical image analyze 400 may include the first side effect analysis model group 410a and the second prosthesis analysis model group 420a. In some examples, as described above, the medical image analysis system 1000 may control the region information generation operations of the first side effect analysis model group 410a and the first prosthesis analysis model group 420a by activating or deactivating the region information generation operations in response to the rupture side effect binary information being positive or negative. Unlike this, regardless of whether the rupture side effect binary information is positive or negative, the medical image analysis system 1000 may generate the binary information and the region information by activating both the binary information generation operation and the region information generation operation of the second side effect analysis model group 410b and the second prosthesis analysis model group 420b.

In some examples, the second side effect analysis model group 410b may include at least one of a silicon coating invasion analysis model 418 or a silicon lymph gland invasion analysis model 419. In addition, the second prosthesis analysis model group 420b may include at least one of a prosthesis component analysis model 424 or a prosthesis location analysis model 425. However, the present disclosure is not limited thereto, and the second side effect analysis model group 410b and the second prosthesis analysis model group 420b may include various analysis models.

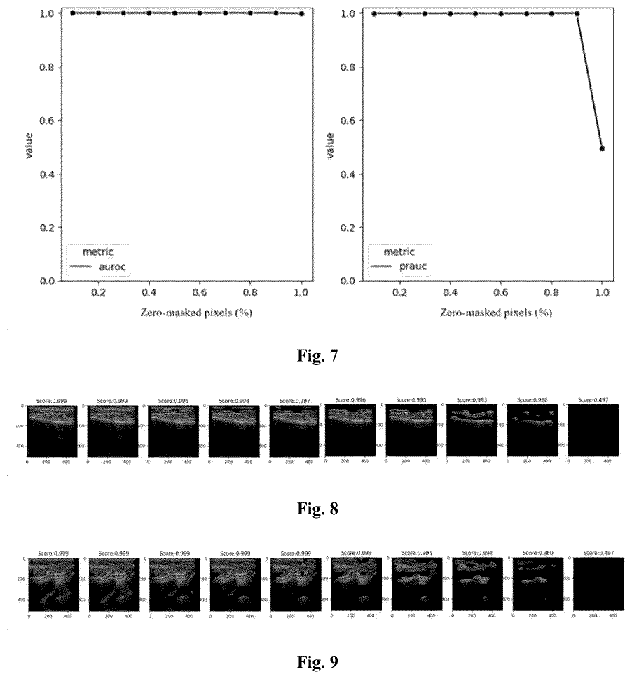

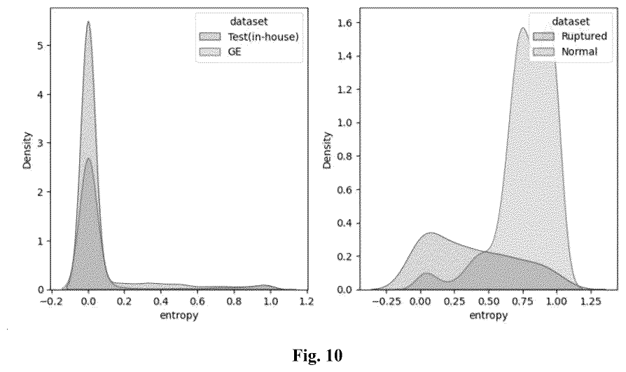

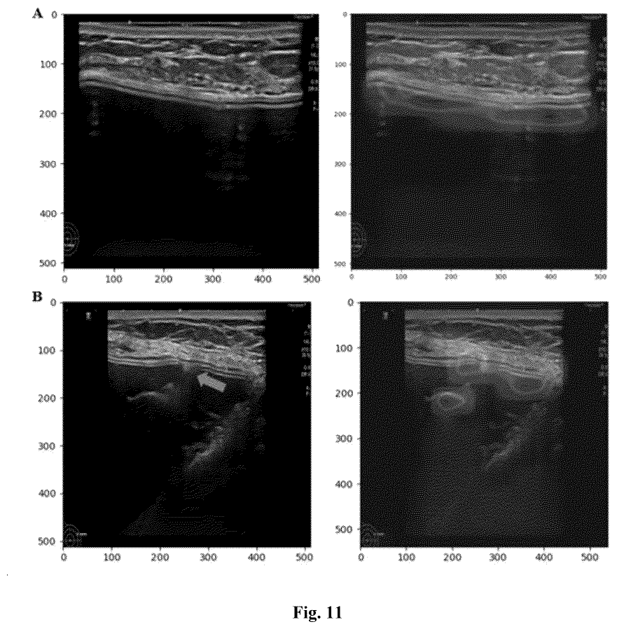

FIG. 6 illustrates an analysis model generation system 2000 according to some embodiments of the present disclosure. FIG. 7 is a diagram for describing a result for quantitative validation of an analysis model according to some embodiments of the present disclosure. FIG. 8 is another diagram for describing a result for quantitative validation of an analysis model according to some embodiments of the present disclosure. FIG. 9 is yet another diagram for describing a result for quantitative validation of an analysis model according to some embodiments of the present disclosure. FIG. 10 is a diagram for describing a result for unpredictability estimation of the analysis model according to some embodiments of the present disclosure. FIG. 11 is a diagram for describing a result for a post-hoc explainable interpretation of the analysis model according to some embodiments of the present disclosure.

In some examples, the analysis model generation system 2000 may generate an analysis model that provides an analysis result for the medical image obtained by photographing the prosthesis inserted into the body. For example, the analysis model generation system 2000 may generate analysis models included in the side effect information generator 410 and the prosthesis information generator 420. Hereinafter, an embodiment regarding the analysis model generation system 2000 that performs a method for generating the analysis model and components thereof according to some embodiments of the present disclosure will be described with reference to FIGS. 6 to 11.

In some examples, as illustrated in FIG. 6, the analysis model generation system 2000 may include a dataset acquirer 2100, a model trainer 2200, and a model evaluator 2300. However, the present disclosure is not limited thereto, and the analysis model generation system 2000 may further include other components for generating the analysis model, and only some of the disclosed components may constitute the analysis model generation system 2000.

Hereinafter, an embodiment in which the analysis model system 2000 generates an analysis model for generating cell type information, such as the prosthesis type analysis model 421, will be described. However, the present disclosure is not limited thereto and the analysis model system 2000 may generate various analysis models.

According to some embodiments of the present disclosure, the analysis model generation system 2000 may acquire, by the dataset acquirer 2100, a first dataset including a medical image obtained by photographing a prosthesis inserted into a body by a first photographing device and a second dataset including a medical image obtained by photographing the prosthesis inserted into the body by a second photographing device.

Specifically, the dataset acquirer 2100 may acquire a dataset used for generating the analysis model in various schemes. For example, the dataset acquirer 2100 may acquire a dataset including a medical image registered through the user interface. As another example, the dataset acquirer 2100 may acquire a dataset including a medical image stored in an external database. However, the present disclosure is not limited thereto, and the dataset acquirer 2100 may acquire the dataset in various schemes.

In some examples, the dataset acquirer 2100 may acquire various types of datasets. For example, the dataset acquirer 210 may acquire medical images photographed by using different photographing devices. For example, the data acquirer 210 may acquire a first dataset including a medical image obtained by photographing the prosthesis inserted into the body by a first photographing device and a second dataset including a medical image obtained by photographing the prosthesis inserted into the body by a second photographing device. Here, the first photographing device may be a photographing device manufactured by a manufacturer different from that of the second photographing device. For example, the first photographing device may be a photographing device manufactured by “Canon”, and the second photographing device may be a photographing device manufactured by “General Electric”. Here, the manufacturer of the photographing device is exemplarily described, and the present disclosure is not limited thereto.

In some examples, the first photographing device may be a photographing device that acquires the medical image at a higher resolution compared to the second photographing device. In this case, the first dataset may include a medical image having a higher resolution compared to the second dataset. As described below, the analysis model generation system 2000 may use the first dataset to train, validate, and test the analysis model. Further, the second dataset may be used to externally validate the analysis model. In other words, the analysis model generation system 2000 may train the analysis model by using only a first dataset including a medical image having a higher resolution among two or more datasets including medical images having different resolutions. The present inventor has found that an analysis model trained by using only a dataset including a medical image having a higher resolution exhibits a higher classification accuracy than an analysis model trained by using a plurality of datasets including medical images having various resolutions in combination. Accordingly, the analysis model generation system 2000 according to some embodiments of the present disclosure may efficiently generate an analysis model by using relatively little training data by validating the trained analysis model by using the first dataset and the second dataset after training the analysis model by using the first dataset. Further, the analysis model generation system 2000 may generate an analysis model that provides high classification accuracy for medical images photographed by various types of photographing devices.

In some examples, the medical image may be an image in which an ultrasound image is stored in a PACS rendered JPEG format. A 128-bit MD5 hash algorithm may be used to exclude data leakage between training and test datasets. In addition, the medical image included in the dataset may have cell type information designated by a breast surgeon with extensive experience in breast prosthesis ultrasound examination as labeling information.

Additionally, the data acquirer 210 may acquire a third dataset including a medical image obtained by photographing a state in which the prosthesis inserted into the body is ruptured and a fourth dataset including a medical image obtained by photographing a state in which no prosthesis is inserted into the body. The third dataset and the fourth dataset may be used as out-of-distribution (OOD) dataset for interpreting the analysis model. In the case of the medical image included in the third dataset, it may be difficult to identify a cell type of the prosthesis due to a damaged cell. In addition, in the case of the medicinal image included in the fourth dataset, since there is no prosthesis on the image, the cell type of the prosthesis may not be identified. Therefore, as described below, the third dataset and the fourth dataset may also be used to determine an ability of the analysis model to estimate an uncertainty of the model with respect to the cell type.

Additionally, the dataset acquirer 210 may include a fifth dataset including a publicly available image. For example, the fifth dataset may include medical images retrieved using keywords such as ‘breast implant ultrasound’ and ‘breast implant ultrasonography’. In some examples, the fifth dataset may be used to externally validate the analysis model. The fifth dataset may be used to confirm an analysis capability of the analysis model with respect to medical images photographed by various photographing devices in that the fifth dataset includes the retrieved medical images without limitation to the photographing device.

Table 1 discloses exemplary datasets used to generate the analysis model.

TABLE 1

| | | | | Cell surface topography | |
|---|---|---|---|---|---|
| | Photographing | | Shell | (N = 19,502) | |
| Dataset | device | Objective | integrity | Texture | Smooth |
| First dataset | Canon | Training, validating, | Intact | 2,420 | 14,976 |
| | | and test | | | |
| Second dataset | GE | External validation | Intact | 113 | 1,844 |
| Third dataset (ruptured | Canon | OOD | Ruptured | 101 | 30 |
| prosthesis image) | | | | | |
| Fourth dataset | Canon | OOD | NA | NA (338) | |
| (Image without | | | | | |
| prosthesis) | | | | | |
| Fifth dataset (publicly | diversified | External validation | Intact | 11 | 7 |
| available image) | | | | | |

According to some embodiments of the present disclosure, the analysis model generation system 2000 may train, by the model trainer 2200, an analysis model for determining cell type information of the prosthesis by using the first dataset. In some examples, the analysis model may use a convolutional neural network architecture in which parameter sizes are adjusted to achieve high performance. The analysis model may use a light model instead of models that require high calculation cost along with large amounts of data due to inductive bias. For example, the analysis model may use a ResNet-50 constituted by 50 layers as a backbone. As another example, the analysis models may use a model architecture having a large number of parameters, such as a vision transformer or a Swin transformer. In some example, the model trainer 2200 may perform transfer training for a pre-trained ResNet 50 that trains ImageNet classification. The pre-trained ResNet 50 may include a binary classification layer that replaces a classification layer having a 1000-dimensional vector for multiple classifications to generate binary information. The binary classification layer may return a two-dimensional vector for a cell surface topology, such as a smooth type and a texture type.

In some examples, the model trainer 2200 may train the analysis model by using a loss function that imposes a higher penalty on misclassification of the texture type than the smooth type among cell type information of the prosthesis. For example, the model trainer 2200 may use a weighted binary cross-entropy as an objective function for parameter optimization. The weighted binary cross entropy may efficiently train the analysis model, by imposing a penalty on misprediction of a minor class due to class imbalance (the texture type is the minor class) between the cell type information. In the weighted binary cross entropy, a weight for the minor class may be calculated as an inverse ratio of the minor class (the texture type) in a training dataset (the first dataset).

In some examples, the model trainer 2200 may perform preprocessing for the medical image included in the dataset. For example, the model trainer 2200 may perform a preprocessing of cutting a side region of the medical image, included in the first dataset or the second dataset, at a predetermined ratio (e.g., 10%, 20%, 30%, or the like). Specifically, the medical image may further include additional information such as text information and metadata along with the image. For example, a PACS rendering image may further include information on patient information, examination information, image metadata, annotations and overlays, associated documents, and the like along with the image, and the like. Since the additional information is generally placed on a side surface of the medical image, the model trainer 2200 may increase training efficiency of the analysis model by cutting the side region in the medical image at a predetermined ratio.

In addition, the model trainer 2200 may resize the medical image to fit input data of the analysis model. For example, the model trainer 2200 may perform a preprocessing of resizing the medical image included in the first dataset to 224×224, which is a size of the input data of the analysis model, by using binary interpolation. However, the present disclosure is not limited thereto and the model trainer 2200 may perform various preprocessings.

In some examples, the model trainer 2200 may train the analysis model at a learning rate of 0.001 and a batch size of 32 by using an Adam optimizer. A total learning epoch is 20, but an actual learning epoch is less than 20 as early stopping is performed by monitoring a validation loss with a patience of 7.

In some examples, the model evaluator 2300 may include various components for evaluating the analysis model trained by the model trainer 2200. As illustrated in FIG. 6, the model evaluator 2300 may include a cross and external validator 2310, a quantitative validator 2320, an unpredictability estimator 2330, and a post-hoc explainable interpreter 2340. The model evaluator 2300 may further include other components for evaluating the analysis model, and only some of the disclosed components may also constitute the model evaluator 2300.

According to some embodiments of the present disclosure, the analysis model generation system 2000 may validate the analysis model by using the first dataset and the second dataset by the cross and external validator 2310.

As described above, the analysis model generation system 2000 may validate the analysis model using the first dataset and the second dataset after training the analysis model using a first dataset including a medical image having a relatively high resolution. Specifically, the cross and external validator 2310 may perform cross-validation for the analysis model by using the first dataset. In addition, the cross and external validator 2310 may perform external validation for the analysis model by using the second dataset.

In some examples, the dataset acquirer 2100 may divide the first dataset into training data (60%), validation data (20%), and test data (20%). Then, the model trainer 2200 may use training data occupying 60% among the first dataset for training the analysis model. The cross and external validator 2310 may cross-validate the analysis model by using validation data occupying 20% among the first dataset. Specifically, for example, the cross and external validator 2310 may perform stratified 5-fold cross validation to identify generalized performance of the analysis model under class imbalance between the smooth type and the text type. The intersection and external validator 2310 may identify an area under the curve AUC by using a receiver operating characteristic (ROC) curve and a precision-recall (PR) curve of different cut-offs for the cross validation. In addition, the cross and external validator 2310 may externally validate the analysis model using the second dataset in order to evaluate the analysis model using an online acquired ultrasonography instead of the training data. The cross and external validator 2310 may confirm AUCs of both ROC and PR by using the data. Further, the cross and external validator 2310 may perform external validation for the analysis model by using the fifth dataset including the publicly available image. However, the present disclosure is not limited thereto, and the cross and external validator 2310 may validate the analysis model in various schemes.

According to some embodiments of the present disclosure, the analysis model generation system 2000 may perform quantitative validation for the analysis model by using a medical image in which a pixel having a low classification contribution according to a predetermined ratio is masked so that the quantitative validator 2320 determines the cell type information of the prosthesis based on a pixel corresponding to a layer of the prosthesis.

In some examples, the quantitative validator 2320 may use an explainable AI approach (XAI) to confirm whether the analysis model may accurately determine the cell type information of the prosthesis by using features of the layer and echogenicity on the medical image such as the ultrasound image. Specifically, the quantitative validator 2320 may perform quantitative validation for evaluating the classification performance according to a masking portion of the medical image. The quantitative validator 2320 may perform the quantitative validation under an assumption that important pixels for determining the cell type of the prosthesis are in the layer of the prosthesis. The quantitative validator 2310 may also perform the quantitative validation under an assumption that there will be no performance degradation even if some of the pixels other than the layer are deleted.

In some examples, the quantitative validator 2320 may calculate a pixel importance by using an algorithm that quantifies the classification contribution. For example, the quantitative validator 2320 may calculate the pixel importance by using ‘Grad-CAM’. The quantitative validator 2320 may remove 90% of pixels having a low classification contribution from all pixels of the medical image, and may calculate AUROC and PRAUC after replacing these values with 0. Accordingly, the quantitative validator 2320 may evaluate whether the cell type information is determined by using the pixel in the layer of the prosthesis. However, the present disclosure is not limited thereto, and the quantitative validator 2320 may perform the quantitative validation in various schemes.

According to some embodiments of the present disclosure, the analysis model generation system 2000 may perform uncertainty estimation for the analysis model by using at least some of the first dataset, the second dataset, the third dataset, or the fourth dataset by the uncertainty estimator 2330.

Specifically, the uncertainty estimator 2330 may calculate an entropy to predict the prediction uncertainty of the medical image. In some examples, the entropy may include a Shannon entropy. The entropy may have a value between 0 and 1. The higher the prediction uncertainty, the higher the entropy may have.

In some examples, the uncertainty estimator 2330 may perform the unpredictability estimation for the analysis model based on the hypothesis that the third dataset has a higher prediction uncertainty than the first dataset or the second dataset and the fourth dataset has a higher prediction uncertainty than the third dataset. Specifically, since the analysis model is trained using the first dataset including the medical image in which the integrity of the cell is not compromised, the third dataset including a medical image obtained by photographing the state in which the prosthesis inserted into the body is ruptured may have a larger entropy than the other datasets. Further, the fourth dataset including a medical image obtained by photographing a state in which the prosthesis is not inserted into the body may have a larger entropy than the third dataset. Accordingly, the uncertainty estimator 2330 may allow the analysis model to calculate a model reliability value for the uncertainty estimation for the analysis model according to a hypothesis that the third dataset has a higher prediction uncertainty than the first dataset or the second dataset and the fourth dataset has a higher prediction uncertainty than the third dataset. Under such a hypothesis, the analysis model generator 2000 may provide an analysis model that may provide model reliability to help a clinician make a decision reflecting uncertainty of diagnosis. However, the present disclosure is not limited thereto, and the uncertainty estimator 2330 may perform the uncertainty estimation in various schemes.

According to some embodiments of the present disclosure, the analysis model generation system 2000 may perform post-hoc explainable interpretation for the analysis model by the post-hoc explainable interpreter 2340 to generate region information representing a pixel related to the cell type information of the prosthesis by using the classification contribution of the pixel to the cell type information of the prosthesis.

Specifically, the post-hoc explainable interpreter 2340 may perform a post-hoc explainable interpretation of the analysis model to acquire an insight into the decision-making processes of the analysis model. In some examples, the post-hoc explainable interpreter 2340 may perform the post-explainable interpretation using a Gradient-weighted Class Activation Mapping (Grad-CAM) technique. The Grad-Cam technique may be used to visually estimate whether there is a match between a prediction pattern of the analysis model and a medical expertise established for the cell type information. The post-hoc explainable interpreter 2340 may cause the analysis model to generate region information representing the pixel related to the cell type information of the prosthesis using the classification contribution of the pixel to the cell type information of the prosthesis. In some examples, the region information may be represented in the heatmap format. In this case, the region information may be used to confirm that the analysis model generates the prediction pattern using pixels indicating clinically important regions by highlighting pixels that are important for determining the cell type information on the medical image.

Although a case where the analysis model is a model for determining the cell type information is described, the post-hoc explainable interpreter 2340 may be used to generate an analysis model for generating the side effect information such as the rupture. When generating the rupture analysis model 411, the post-hoc explainable interpreter 2340 may allow the rupture analysis model 411 to generate region information representing a region where the rupture occurs on the medical image. However, the present disclosure is not limited thereto and the post-hoc explainable interpreter 2340 may perform the post-explainable interpretation for various analysis models.

Hereinafter, an evaluation result of an exemplary analysis model according to some embodiments of the present disclosure will be described.

TABLE 2

| | Dataset | | | |
|---|---|---|---|---|
| | First | Second | Third dataset | Fifth dataset |
| | dataset | dataset | (Ruptured | (Publicly available |
| Metric | (canon) | (GE) | prosthesis image) | image) |
| AUROC | 0.998 | 0.985 | 0.995 | 0.909 |
| PRAUC | 0.994 | 0.748 | 0.998 | 0.958 |

Referring to Table 2, the exemplary analysis model exhibited performances of an AUROC at 0.998 and a PRAUC at 0.994 for the test dataset included in the first dataset. In the stratified 5-fold cross validation, the analysis model showed an AUROC at 0.98 and a PRAUC at 0.88 on average for the first dataset including the medical image obtained by the first photographing device. For the second dataset photographed by the second photographing device, the analysis model also showed an AUROC at 0.985 and a PRAUC at 0.748. For the fifth dataset including the publicly available image, the analysis model showed an AUROC at 0.909 and a PRAUC at 0.958. This may suggest that the analysis model generates accurate analysis results for various photographing devices other than the photographing device that photographs the medical image included in the training data. Referring to FIG. 7, for a result of quantitative validation to confirm that the analysis model classifies medical images according to medical knowledge, the analysis model exhibited an AUROC at 0.999 when masking 90% of pixels with a low classification contribution. In addition, the analysis model showed an AUROC at 0.997 when masking 100% of the pixels. However, the PRAUC maintained 0.999 when masking 90% of the pixels, but dropped to 0.493 when masking 100% of the pixels. Referring to FIG. 8, for individual cases, a reliability for the texture cell type maintained 0.993 when masking 80% or less of the pixels contributing to the prediction. When masking 90% of the pixels, a model reliability decreased to 0.968 and reached 0.497 when masking all pixels. Similarly, for the other case for the texture cell type, the model reliability maintained 0.994 until masking 80% of the pixels. Then, when 90% of the pixels were masked, the model reliability decreased to 0.960. Then, when 100% of the pixels were masked, the model reliability decreased to 0.947. In other words, the analysis model maintained high accuracy even when pixels with the low classification contribution were removed. This may suggest that the analysis model performs a prediction depending on key information.

Referring to FIG. 10, as a result of the uncertainty estimation, the analysis model did not show a significantly lower entropy for the first dataset compared to the second dataset that performs the external validation (mean [SD], 0.072 [0.201] vs 0.066 [0.21]; p=0.350). This may be interpreted as the analysis model exhibiting similar a predictive stability for the medical image photographed by the first photographing device and the medical image photographed by the second photographing device. The mean entropy for the third dataset was significantly higher than the first dataset (mean [SD], 0.371 [0.318] vs 0.072 [0.201]; p<0.001). This may be interpreted as having a greater prediction uncertainty when the analysis model analyzes a ruptured prosthesis image. In addition, the analysis model showed statistically significantly higher entropy for the fourth dataset containing images without prosthesis compared to the third dataset (mean [SD], 0.777 [0.199] vs. 0.371 [0.318]; p<0.001). This may be interpreted as having a greater prediction uncertainty when the analysis model analyzes an image without the prosthesis compared to the ruptured prosthesis image. This may suggest that the uncertainty estimation of the analysis model may be robustly quantified. Accordingly, the analysis model generator 2000 according to some embodiments of the present disclosure may provide an analysis model that may provide model reliability to help a clinician make a decision reflecting uncertainty.

Referring to FIG. 11, for qualitative case review, one medical image was sampled from the first dataset and the other one was sampled from the third dataset. Both medical images were images generated by the same photographing device. The analysis model showed a model reliability of 0.998 for the texture type for the medical image for the texture type. A Grad-CAM score for the texture type showed a high value in the heatmap (a white horizontal line in FIG. 11A). Further, the analysis model showed a model reliability of 0.664 for the texture type for a ruptured texture type of prosthesis image. The score is higher than a classification threshold (0.5), but lower than an intact texture type of prosthesis. However, despite the rupture, the Grad-CAM score showed a high value at an intact layer adjacent to an area with a ruptured cell. An arrow shown in a left image in FIG. 11B indicates a location where the rupture occurs in a cell of the prosthesis. Here, referring to a right image in FIG. 11B, the heatmap is shown along a layer adjacent to the location where the rupture occurs in the cell of the prosthesis. This may suggest that the analysis model responds with high reliability to the intact layer regardless of whether there is the rupture.

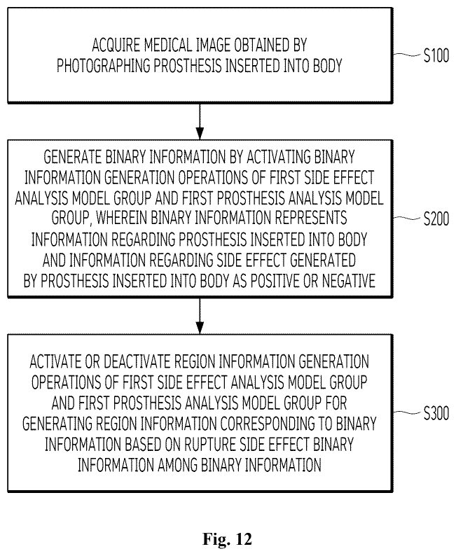

FIG. 12 is a flowchart of a medical image analysis method according to some embodiments of the present disclosure.

According to some embodiments of the present disclosure, the medical image analysis method may include a step (S100) of acquiring a medical image obtained by photographing a prosthesis inserted into a body.

According to some embodiments of the present disclosure, the medical image analysis method may include a step (S200) of generating binary information by activating binary information generation operations of a first side effect analysis model group and a first prosthesis analysis model group. Here, the binary information may represent information regarding the prosthesis inserted into the body and information regarding a side effect caused by the prostheses inserted into the body as positive or negative.

According to some embodiments of the present disclosure, the medical image analysis method may include a step (S300) of activating or deactivating the first side effect analysis model group and the first prosthesis analysis model group that generate region information corresponding to the binary information based on rupture side effect binary information among the binary information.

Alternatively, the step S300 of activating or deactivating the region information generation operations of the first side effect analysis model group and the first prosthesis analysis model group for generating the region information corresponding to the binary information based on the rupture side effect binary information among the binary information may include: a step of activating the region information generation operation of the first sides effect analysis model group or the first prosthesis analysis model group in response to the rupture side effect binary information being negative, thereby generating the region information that corresponds to the binary information by the region information generation operations of the first side effect analysis model group and the first prosthesis analysis model group; and a step deactivating the region information generation operation of the first side effect analysis model group and the first prosthesis analysis model group in responses to the rupture side effect binary information being positive.

Alternatively, the deactivating of the region information generation operations of the first side effect analysis model group and the first prosthesis analysis model group in response to the rupture side effect binary information being positive may include deactivating region information generation sub models of the first side effect analysis model group and the first prosthesis analysis model group in response to deactivating the region information generation operations of the first side effect analysis model group and the first prosthesis analysis model group.

Alternatively, the deactivating of the region information generation operations of the first side effect analysis model group and the first prosthesis analysis model group in response to the rupture side effect binary information being positive may include deactivating an operation of calculating a classification contribution to the binary information of pixels included in the medical image of the first side effect analysis model group and the first prosthesis analysis model group in response to deactivating the region information generation operations of the first side effect analysis model group and the first prosthesis analysis model group.

Alternatively, the first side effect analysis model group may include at least one of a thickened capsule analysis model, a folding analysis model, a fluid collection analysis model, an upside-down rotation analysis model, a coating calcification analysis model, or a coating nodule analysis model.

Alternatively, the first prosthesis analysis model group may include at least one of a prosthesis type analysis model, a prosthesis shape analysis model, or a prosthesis manufacturer analysis model.

Alternatively, the medical image analysis method may further include generating, by a second side effect analysis model group and a second prosthesis analysis model group, the binary information and region information corresponding to the binary information by processing the acquired medical image.

Alternatively, the second side effect analysis model group may include at least one of a silicon coating invasion analysis model or a silicon lymph gland invasion analysis model.

Alternatively, the second group of prosthesis analysis models may include at least one of a prosthesis component analysis model or a prosthesis location analysis model.

Alternatively, the region information may be represented in a heatmap format.

The steps of the medical image analysis method described above are presented just for description, and some steps may be omitted or separate steps may be added. Further, the above-described steps may be performed according to an arbitrary order.

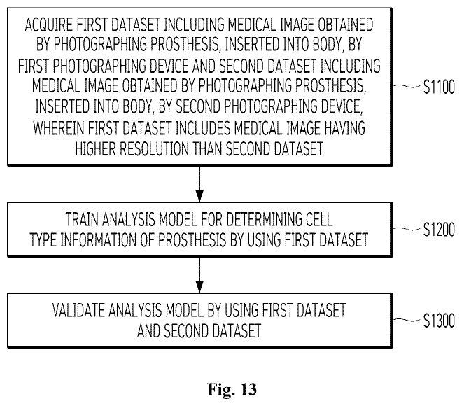

FIG. 13 is a flowchart of a method for generating an analysis model according to some embodiments of the present disclosure.

According to some embodiments of the present disclosure, a method for generating an analysis model for determining cell type information of a prosthesis inserted into a body may include a step (S1100) of acquiring a first dataset including a medical image obtained by photographing the prosthesis inserted into the body by a first photographing device and a second dataset including a medical image obtained by photographing the prosthesis inserted into the body by a second photographing device. Here, the first dataset may include a medical image having a higher resolution than the second dataset.

According to some embodiments of the present disclosure, the method for generating the analysis model may include a step (S1200) of training the analysis model for determining the cell type information of the prosthesis by using the first dataset.

According to some embodiments of the present disclosure, the method for generating the analysis model may include a step (S1300) of validating the analysis model by using the first dataset and the second dataset.

Alternatively, the first photographing device may be a photographing device manufactured by a different manufacturer from the second photographing device.

Alternatively, the method for generating the analysis model may further include a step of performing a preprocessing of cutting a side area of a medical image included in the second dataset or the second dataset at a predetermined ratio.

Alternatively, the step (S1200) of training of the analysis model for determining the cell type information of the prosthesis by using the first dataset may include a step of training the analysis model by using a loss function that imposes a high penalty to misclassification for a texture type compared to a smooth type among the cell type information.

Alternatively, the step (S1300) of validating of the analysis model by using the first dataset and the second dataset may include a step of performing cross validation for the analysis model by using the first dataset; and a step of performing external validation for the analysis model by using the second dataset.

Alternatively, the step (S1300) of validating of the analysis model by using the first dataset and the second dataset may further include a step of performing the external validation for the analysis model by additionally using a fifth dataset including a publicly available image.

Alternatively, the method for generating the analysis model may further include a step of performing quantitative validation for the analysis model by using a medical image in which a pixel having a low classification contribution is masked according to a predetermined ratio to determine the cell type information of the prosthesis based on a pixel corresponding to a layer of the prosthesis.

Alternatively, the method for generating the analysis model may further include: a step of acquiring a third dataset including a medical image obtained by photographing a state in which the prosthesis inserted into the body is ruptured and a fourth dataset including a medical image obtained by photographing a state in which no prosthesis is inserted into the body; and a step of performing uncertainty estimation for the analysis model by using at least some of the first dataset, the second dataset, the third dataset, or the fourth dataset.

Alternatively, the step of performing of the uncertainty estimation for the analysis model by using at least some of the first dataset, the second dataset, the third dataset, or the fourth dataset may include a step of performing uncertainty estimation for the analysis model based on a hypothesis that the third dataset has a higher prediction uncertainty than the first dataset or the second dataset and the fourth dataset has a higher prediction uncertainty than the third dataset.

Alternatively, the method for generating the analysis model may further include a step of performing post-hoc explainable interpretation for the analysis model to generate region information representing a pixel related to the cell type information of the prosthesis using a classification contribution of the pixel to the cell type information of the prosthesis.

Alternatively, the region information may be represented in a heatmap format. The steps of the method for generating the analysis model described above are presented just for description, and some steps may be omitted or separate steps may be added. Further, the above-described steps may be performed according to an arbitrary order.

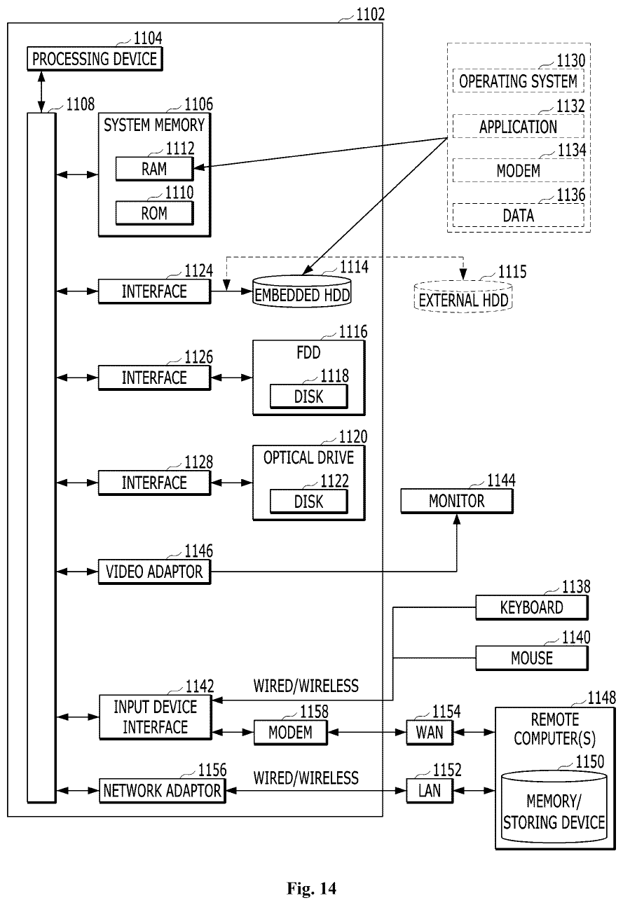

FIG. 14 is a simple and general schematic view of an exemplary computing environment in which exemplary embodiments of the present disclosure may be implemented.

It is described above that the present disclosure may be generally implemented by the computing device, but those skilled in the art will well know that the present disclosure may be implemented in association with a computer executable command which may be executed on one or more computers and/or in combination with other program modules and/or as a combination of hardware and software.

In general, the program module includes a routine, a program, a component, a data structure, and the like that execute a specific task or implement a specific abstract data type. Further, it will be well appreciated by those skilled in the art that the method of the present disclosure can be implemented by other computer system configurations including a personal computer, a handheld computing device, microprocessor-based or programmable home appliances, and others (the respective devices may operate in connection with one or more associated devices as well as a single-processor or multi-processor computer system, a mini computer, and a main frame computer.

The exemplary embodiments described in the present disclosure may also be implemented in a distributed computing environment in which predetermined tasks are performed by remote processing devices connected through a communication network. In the distributed computing environment, the program module may be positioned in both local and remote memory storage devices.

The computer generally includes various computer readable media. Media accessible by the computer may be computer readable media regardless of types thereof and the computer readable media include volatile and non-volatile media, transitory and non-transitory media, and mobile and non-mobile media. As a non-limiting example, the computer readable media may include both computer readable storage media and computer readable transmission media. The computer readable storage media include volatile and non-volatile media, transitory and non-transitory media, and mobile and non-mobile media implemented by a predetermined method or technology for storing information such as a computer readable instruction, a data structure, a program module, or other data. The computer readable storage media include a RAM, a ROM, an EEPROM, a flash memory or other memory technologies, a CD-ROM, a digital video disk (DVD) or other optical disk storage devices, a magnetic cassette, a magnetic tape, a magnetic disk storage device or other magnetic storage devices or predetermined other media which may be accessed by the computer or may be used to store desired information, but are not limited thereto.

The computer readable transmission media generally implement the computer readable command, the data structure, the program module, or other data in a carrier wave or a modulated data signal such as other transport mechanism and include all information transfer media. The term “modulated data signal” means a signal acquired by setting or changing at least one of characteristics of the signal so as to encode information in the signal. As a non-limiting example, the computer readable transmission media include wired media such as a wired network or a direct-wired connection and wireless media such as acoustic, RF, infrared and other wireless media. A combination of any media among the aforementioned media is also included in a range of the computer readable transmission media.

An exemplary environment that implements various aspects of the present disclosure including a computer 1102 is shown and the computer 1102 includes a processing device 1104, a system memory 1106, and a system bus 1108. The system bus 1108 connects system components including the system memory 1106 (not limited thereto) to the processing device 1104. The processing device 1104 may be a predetermined processor among various commercial processors. A dual processor and other multi-processor architectures may also be used as the processing device 1104.

The system bus 1108 may be any one of several types of bus structures which may be additionally interconnected to a local bus using any one of a memory bus, a peripheral device bus, and various commercial bus architectures. The system memory 1106 includes a read only memory (ROM) 1110 and a random access memory (RAM) 1112. A basic input/output system (BIOS) is stored in the non-volatile memories 1110 including the ROM, the EPROM, the EEPROM, and the like and the BIOS includes a basic routine that assists in transmitting information among components in the computer 1102 at a time such as in-starting. The RAM 1112 may also include a high-speed RAM including a static RAM for caching data, and the like.

The computer 1102 also includes an interior hard disk drive (HDD) 1114 (for example, EIDE and SATA), in which the interior hard disk drive 1114 may also be configured for an exterior purpose in an appropriate chassis (not illustrated), a magnetic floppy disk drive (FDD) 1116 (for example, for reading from or writing in a mobile diskette 1118), and an optical disk drive 1120 (for example, for reading a CD-ROM disk 1122 or reading from or writing in other high-capacity optical media such as the DVD, and the like). The hard disk drive 1114, the magnetic disk drive 1116, and the optical disk drive 1120 may be connected to the system bus 1108 by a hard disk drive interface 1124, a magnetic disk drive interface 1126, and an optical drive interface 1128, respectively. An interface 1124 for implementing an exterior drive includes at least one of a universal serial bus (USB) and an IEEE 1394 interface technology or both of them.

The drives and the computer readable media associated therewith provide non-volatile storage of the data, the data structure, the computer executable instruction, and others. In the case of the computer 1102, the drives and the media correspond to storing of predetermined data in an appropriate digital format. In the description of the computer readable media, the mobile optical media such as the HDD, the mobile magnetic disk, and the CD or the DVD are mentioned, but it will be well appreciated by those skilled in the art that other types of media readable by the computer such as a zip drive, a magnetic cassette, a flash memory card, a cartridge, and others may also be used in an exemplary operating environment and further, the predetermined media may include computer executable commands for executing the methods of the present disclosure.

Multiple program modules including an operating system 1130, one or more application programs 1132, other program module 1134, and program data 1136 may be stored in the drive and the RAM 1112. All or some of the operating system, the application, the module, and/or the data may also be cached in the RAM 1112. It will be well appreciated that the present disclosure may be implemented in operating systems which are commercially usable or a combination of the operating systems.

A user may input instructions and information in the computer 1102 through one or more wired/wireless input devices, for example, pointing devices such as a keyboard 1138 and a mouse 1140. Other input devices (not illustrated) may include a microphone, an IR remote controller, a joystick, a game pad, a stylus pen, a touch screen, and others. These and other input devices are often connected to the processing device 1104 through an input device interface 1142 connected to the system bus 1108, but may be connected by other interfaces including a parallel port, an IEEE 1394 serial port, a game port, a USB port, an IR interface, and others.

A monitor 1144 or other types of display devices are also connected to the system bus 1108 through interfaces such as a video adapter 1146, and the like. In addition to the monitor 1144, the computer generally includes other peripheral output devices (not illustrated) such as a speaker, a printer, others.

The computer 1102 may operate in a networked environment by using a logical connection to one or more remote computers including remote computer(s) 1148 through wired and/or wireless communication. The remote computer(s) 1148 may be a workstation, a computing device computer, a router, a personal computer, a portable computer, a micro-processor based entertainment apparatus, a peer device, or other general network nodes and generally includes multiple components or all of the components described with respect to the computer 1102, but only a memory storage device 1150 is illustrated for brief description. The illustrated logical connection includes a wired/wireless connection to a local area network (LAN) 1152 and/or a larger network, for example, a wide area network (WAN) 1154. The LAN and WAN networking environments are general environments in offices and companies and facilitate an enterprise-wide computer network such as Intranet, and all of them may be connected to a worldwide computer network, for example, the Internet.

When the computer 1102 is used in the LAN networking environment, the computer 1102 is connected to a local network 1152 through a wired and/or wireless communication network interface or an adapter 1156. The adapter 1156 may facilitate the wired or wireless communication to the LAN 1152 and the LAN 1152 also includes a wireless access point installed therein in order to communicate with the wireless adapter 1156. When the computer 1102 is used in the WAN networking environment, the computer 1102 may include a modem 1158 or has other means that configure communication through the WAN 1154 such as connection to a communication computing device on the WAN 1154 or connection through the Internet. The modem 1158 which may be an internal or external and wired or wireless device is connected to the system bus 1108 through the serial port interface 1142. In the networked environment, the program modules described with respect to the computer 1102 or some thereof may be stored in the remote memory/storage device 1150. It will be well known that an illustrated network connection is exemplary and other means configuring a communication link among computers may be used.

The computer 1102 performs an operation of communicating with predetermined wireless devices or entities which are disposed and operated by the wireless communication, for example, the printer, a scanner, a desktop and/or a portable computer, a portable data assistant (PDA), a communication satellite, predetermined equipment or place associated with a wireless detectable tag, and a telephone. This at least includes wireless fidelity (Wi-Fi) and Bluetooth wireless technology. Accordingly, communication may be a predefined structure like the network in the related art or just ad hoc communication between at least three devices.

The wireless fidelity (Wi-Fi) enables connection to the Internet, and the like without a wired cable. The Wi-Fi is a wireless technology such as the device, for example, a cellular phone which enables the computer to transmit and receive data indoors or outdoors, that is, anywhere in a communication range of a base station. The Wi-Fi network uses a wireless technology called IEEE 802.11 (a, b, g, and others) in order to provide safe, reliable, and high-speed wireless connection. The Wi-Fi may be used to connect the computers to each other or the Internet and the wired network (using IEEE 802.3 or Ethernet). The Wi-Fi network may operate, for example, at a data rate of 11 Mbps (802.11a) or 54 Mbps (802.11b) in unlicensed 2.4 and 5 GHz wireless bands or operate in a product including both bands (dual bands).

It will be appreciated by those skilled in the art that information and signals may be expressed by using various different predetermined technologies and techniques. For example, data, instructions, commands, information, signals, bits, symbols, and chips which may be referred in the above description may be expressed by voltages, currents, electromagnetic waves, magnetic fields or particles, optical fields or particles, or predetermined combinations thereof.

It may be appreciated by those skilled in the art that various exemplary logical blocks, modules, processors, means, circuits, and algorithm steps described in association with the exemplary embodiments disclosed herein may be implemented by electronic hardware, various types of programs or design codes (for easy description, herein, designated as software), or a combination of all of them. In order to clearly describe the intercompatibility of the hardware and the software, various exemplary components, blocks, modules, circuits, and steps have been generally described above in association with functions thereof. Whether the functions are implemented as the hardware or software depends on design restrictions given to a specific application and an entire system. Those skilled in the art of the present disclosure may implement functions described by various methods with respect to each specific application, but it should not be interpreted that the implementation determination departs from the scope of the present disclosure.

Various embodiments presented herein may be implemented as manufactured articles using a method, a device, or a standard programming and/or engineering technique. The term manufactured article includes a computer program, a carrier, or a medium which is accessible by a predetermined computer-readable storage device. For example, a computer-readable storage medium includes a magnetic storage device (for example, a hard disk, a floppy disk, a magnetic strip, or the like), an optical disk (for example, a CD, a DVD, or the like), a smart card, and a flash memory device (for example, an EEPROM, a card, a stick, a key drive, or the like), but is not limited thereto. Further, various storage media presented herein include one or more devices and/or other machine-readable media for storing information.

It will be appreciated that a specific order or a hierarchical structure of steps in the presented processes is one example of exemplary accesses. It will be appreciated that the specific order or the hierarchical structure of the steps in the processes within the scope of the present disclosure may be rearranged based on design priorities. Appended method claims provide elements of various steps in a sample order, but the method claims are not limited to the presented specific order or hierarchical structure.

The description of the presented exemplary embodiments is provided so that those skilled in the art of the present disclosure use or implement the present disclosure. Various modifications of the exemplary embodiments will be apparent to those skilled in the art and general principles defined herein can be applied to other exemplary embodiments without departing from the scope of the present disclosure. Therefore, the present disclosure is not limited to the exemplary embodiments presented herein, but should be interpreted within the widest range which is coherent with the principles and new features presented herein.

What is claimed is:

1. A method for generating an analysis model for determining cell type information of a prosthesis inserted into a body, performed by a computing device, the method comprising:
acquiring a first dataset including a medical image obtained by photographing the prosthesis, inserted into the body, by a first photographing device and a second dataset including a medical image obtained by photographing the prosthesis, inserted into the body, by a second photographing device, wherein the first dataset includes a medical image having a higher resolution than the second dataset;
training an analysis model for determining cell type information of the prosthesis by using the first dataset; and
validating the analysis model by using the first dataset and the second dataset.

2. The method of claim 1, wherein the first photographing device is a photographing device manufactured by a different manufacturer from the second photographing device.

3. The method of claim 1, further comprising:
performing a preprocessing of cutting a side area of a medical image, included in the first dataset or the second dataset, at a predetermined ratio.

4. The method of claim 1, wherein the training of the analysis model for determining the cell type information of the prosthesis by using the first dataset includes
training the analysis model by using a loss function that imposes a high penalty to misclassification for a texture type compared to a smooth type among the cell type information of the prosthesis.

5. The method of claim 1, wherein the validating of the analysis model by using the first dataset and the second dataset includes:
performing cross validation for the analysis model by using the first dataset; and
performing external validation for the analysis model by using the second dataset.

6. The method of claim 4, wherein the validating of the analysis model by using the first dataset and the second dataset includes
performing the external validation for the analysis model by additionally using a fifth dataset including a publicly available image.

7. The method of claim 1, further comprising:
performing quantitative validation for the analysis model by using a medical image in which a pixel having a low classification contribution is masked according to a predetermined ratio to determine the cell type information of the prosthesis based on a pixel corresponding to a layer of the prosthesis.

8. The method of claim 1, further comprising:
acquiring a third dataset including a medical image obtained by photographing a state in which the prosthesis inserted into the body is ruptured and a fourth dataset including a medical image obtained by photographing a state in which no prosthesis is inserted into the body; and
performing uncertainty estimation for the analysis model by using at least some of the first dataset, the second dataset, the third dataset, or the fourth dataset.

9. The method of claim 8, wherein the performing of the uncertainty estimation for the analysis model by using at least some of the first dataset, the second dataset, the third dataset, or the fourth dataset includes
performing uncertainty estimation for the analysis model based on a hypothesis that the third dataset has a higher prediction uncertainty than the first dataset or the second dataset and the fourth dataset has a higher prediction uncertainty than the third dataset.

10. The method of claim 1, further comprising:
performing post-hoc explainable interpretation for the analysis model to generate region information representing a pixel related to the cell type information of the prosthesis using a classification contribution of the pixel to the cell type information of the prosthesis.

11. The method of claim 10, wherein the region information is represented in a heatmap format.

12. A computer program stored in a computer readable storage medium, wherein the computer program includes instructions for causing one or more processors to perform a method, and the method comprises:
acquiring a first dataset including a medical image obtained by photographing the prosthesis, inserted into the body, by a first photographing device and a second dataset including a medical image obtained by photographing the prosthesis, inserted into the body, by a second photographing device, wherein the first dataset includes a medical image having a higher resolution than the second dataset;
training an analysis model for determining cell type information of the prosthesis by using the first dataset; and
validating the analysis model by using the first dataset and the second dataset.

13. A computing device performing a method, the computing device comprising:
a memory; and
a processor,
wherein the processor is configured to:
acquire a first dataset including a medical image obtained by photographing the prosthesis, inserted into the body, by a first photographing device and a second dataset including a medical image obtained by photographing the prosthesis, inserted into the body, by a second photographing device, wherein the first dataset includes a medical image having a higher resolution than the second dataset;
train an analysis model for determining cell type information of the prosthesis by using the first dataset; and
validate the analysis model by using the first dataset and the second dataset.
